(19) United States
(12) Patent Application Publication
(10) Pub. No.: US 2024/0353981 A1
(43) Pub. Date: Oct. 24, 2024

(54) SYSTEM AND METHODS FOR INDEXING, CURATING AND PRESENTING CONTENT

(71) Applicant: EDYou LLC, Marina Del Rey, CA (US)

(72) Inventor: Rees Horton, Marine Del Rey, CA (US)

(21) Appl. No.: 18/639,618

(22) Filed: Apr. 18, 2024

Related U.S. Application Data
(60) Provisional application No. 63/460,178, filed on Apr. 18, 2023.

(51) Int. Cl. G06F 3/0484; H04L 67/306

(52) U.S. Cl. CPC G06F 3/0484; H04L 67/306

(57) ABSTRACT

System and method causing display, at a client device, of a user interface (UI) that includes a first view of a content collection that includes concept pairs and associated relationship links, the first view including a first concept and a user-selectable access mode interface element; upon detecting a first user selection of the user-selectable access mode interface element, causing display of a second view of the content collection, the second view including a second concept and being generated based on at least access mode attributes and a user profile for the user. In some examples, the method further causes display of a set of selectable content items generated based on one or more of at least the user profile, respective relationship links connecting the selectable content items to the first concept, characteristics of the content items, or characteristics of user interactions with content items in the content collection.

### CROSS-REFERENCE TO RELATED APPLICATIONS

This application claims the benefit of priority to U.S. Provisional Application 63/460,178, filed Apr. 18, 2023, which is hereby incorporated by reference in its entirety.

### TECHNICAL FIELD

Embodiments of the present disclosure relate generally to the field of online education platforms and, more particularly, but not by way of limitation, to an architecture for systems and methods for indexing, curating and presenting content, such as educational content.

### BACKGROUND

The organization and delivery of educational resources or skill-building resources by educational institutions, products, and services has a number of potential goals including providing access to quality materials that can be navigated in multiple ways, and tailoring the learning experience to the interests and aptitude of each learner.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example system for indexing, curating and displaying content in accordance with some embodiments.

FIG. 2 is a block diagram illustrating a learning studio application, according to some examples.

FIG. 3 is an illustration of an user interface (UI) displayed in connection with one or more modules of a learning studio application, according to some examples.

FIG. 4 is an illustration of a UI displayed in connection with one or more modules of a learning studio application, according to some examples.

FIG. 5 is an illustration of a UI displayed in connection with one or more modules of a learning studio application, according to some examples.

FIG. 6 is an illustration of a UI displayed in connection with one or more modules of a learning studio application, according to some examples.

FIG. 7 is an illustration of a UI displayed in connection with one or more modules of a learning studio application, according to some examples.

FIG. 8 is an illustration of a UI displayed in connection with one or more modules of a learning studio application, according to some examples.

FIG. 9 is an illustration of a UI displayed in connection with one or more modules of a learning studio application, according to some examples.

FIG. 10 is an illustration of a UI displayed in connection with one or more modules of a learning studio application, according to some examples.

FIG. 11 is an illustration of a UI displayed in connection with one or more modules of a learning studio application, according to some examples.

FIG. 12 is an illustration of a UI displayed in connection with one or more modules of a learning studio application, according to some examples.

FIG. 13 is an illustration of a UI displayed in connection with one or more modules of a learning studio application, according to some examples.

FIG. 14 is an illustration of a UI displayed in connection with one or more modules of a learning studio application, according to some examples.

FIG. 15 is an illustration of a UI displayed in connection with one or more modules of a learning studio application, according to some examples.

FIG. 16 is an illustration of a UI displayed in connection with one or more modules of a learning studio application, according to some examples.

FIG. 17 is an illustration of a UI displayed in connection with one or more modules of a learning studio application, according to some examples.

FIG. 18 is an illustration of a UI displayed in connection with one or more modules of a learning studio application 112, according to some examples.

FIG. 19 is an illustration of a UI displayed in connection with one or more modules of a learning studio application, according to some examples.

FIG. 20 is an illustration of a UI displayed in connection with one or more modules of a learning studio application, according to some examples.

FIG. 21 is a block diagram illustrating a moderator studio application, according to some examples.

FIG. 22 is an illustration of a UI for curating content collections, according to some examples.

FIG. 23 is an illustration of a UI for curating content collections, according to some examples.

FIG. 24 is an illustration of a UI for curating content collections, according to some examples.

FIG. 25 is an illustration of a UI for curating content collections, according to some examples.

FIG. 26 is a block diagram illustrating a view of a collection, according to some examples.

FIG. 27 is a block diagram illustrating a partial view of a relationship ontology, according to some examples.

FIG. 28 is a block diagram illustrating a partial view of a relationship ontology, according to some examples.

FIG. 29 is a block diagram illustrating views of two initial collections and a view of a combined collection, according to some examples.

FIG. 30 is a block diagram illustrating a view of a collection, according to some examples.

FIG. 31 is a diagrammatic illustration of node and edge collections, according to some examples.

FIG. 32 is a diagrammatic illustration of a navigable graph generated based on node and edge collections, according to some examples.

FIG. 33 is an illustration of a partial view of a content collection.

FIG. 34 is a flowchart illustrating a method for accessing a content collection, according to some examples.

FIG. 35 is a block diagram illustrating components of a machine, according to some example embodiments, able to read instructions from a machine-readable medium and perform any one or more of the methodologies discussed herein.

FIG. 36 is a block diagram showing a machine-learning program according to some examples.

### DETAILED DESCRIPTION

Various education platforms provide products and services to organize and deliver educational resources to learners with different goals, interests and aptitudes. However, traditional development and presentation of educational resources is influenced by factors unrelated to the content or learner themselves, but rather due to factors such as development cost and market viability, which often result in a non-differentiated learning experience using a linear, sequential navigation model based on curriculums. While curriculums are broadly used, they can be difficult to adjust or navigate while accommodating a variety of learner needs and experiences. Furthermore, educators and tutors may be interested in creating new educational experiences tailored to specific learners or learner communities.

The present disclosure describes a system for creating, curating, and presenting a content index. Example embodiments described herein refer to a system where a content index is a multi-level index, in which content items such as instructional YouTube videos, Wikipedia articles or educator-created materials are mapped to underlying concepts or topics, and the concepts are mapped to each other (e.g., based on concept-level relationships defined by an ontology). In some examples, the system allows for the construction and presentation of multiple content indexes, corresponding to one or more content collections of concepts and/or associated educational resources.

A collection includes a set of concepts and/or content items such as educational resources. Concepts are connected by concept-level relationships. Concepts are connected to content items or educational resources via concept-resource relationships. Educational resources are connected via educational resource-level relationships. In some examples, relationships used by collections are defined in an ontology. Relationships can be n-ary, connecting concepts in a concept pair, in a concept triple, or in a N-size tuple, where N>3 (similarly, connected tuples of educational resources can have multiple elements). A concept tuple can appear in multiple collections and/or be associated with the same relationship across the collections. The concept tuple can be associated with different relationships in different collections. In some examples, these different relationships can be part of one or more shared relationship ontologies across the multiple collections. Similarly, a concept and a resource, or a pair of educational resources, can be connected via the same or different relationships in different collections. In this manner, different collections can refer to shared knowledge domains and/or topics, but differ as to teaching goals, philosophies and so forth. Each collection can correspond to a knowledge graph or knowledge map. In some examples, the system aggregates individual collections into superset, aggregate collections corresponding to complete knowledge graphs or knowledge maps. Complete knowledge maps represent a default, overall set of concepts and/or relationships for a content indexing system. In some examples, the system enables a user to traverse from one collection to another, switch from a collection to a complete knowledge graph and back, or facilitates other interoperability use cases for multiple collections and/or a complete knowledge graph or knowledge map. In some examples, complete knowledge maps or knowledge graphs are created first, and individual collections are created based on the complete knowledge maps, for example by selecting a set of concepts, a set of content items and/or a set of associated relationship links.

In some examples, accessing a content index or content collection is based on an access mode. The access mode can be determined by detecting a user selection of a selectable access mode element in a UI. Example access modes include searching, exploring, focusing, adding content, editing content, and so forth. In some examples, the system allows different types of users to access a content collection and/or the content index using a subset of access modes, based on user profile attributes or device attributes.

In some examples, a user accessing displayed curated content can be referred to as a “learner.” A user can be designated as a “learner” based on one or more user attributes associated with a corresponding user account. A learner studies educational content, and can access or navigate content via one or more “access modes” that include a search mode, an explore mode, a focus mode, a quiz mode or assessment mode, a review mode, a daily learning mode, and so forth. In some examples, the various access or interaction modes are associated with different types of educational experiences, involving different types of educational resources, such as learning resources or testing resources.

A learner navigates through a presented content index or content collection by following one or more navigation paths automatically derived or customized based on one or more factors. Example factors include relationships between concepts, the mapping of content items to concepts, a current user access mode (e.g., explore vs. focus), user profile data including user attributes and/or preferences of the user, a corresponding user population or group associated with the user, resource profile data or characteristics (e.g., content item profile data or characteristics), performance data captured from testing resources by users (for instance learners) who have used a specific resource, the performance data including information about sessions during which users navigated to alternative resources for the same concept, and so forth. In some examples, resource profile data includes a duration associated with the resource, demographic characteristics of a resource's content creator, its views both in the context of the system and in the original source, publishing date, last access date, and so forth. In some examples, a user's profile includes a user's background, salient demographic characteristics (e.g., age, location), educational goals, preferences regarding the type of navigational path, progress with respect to one or more benchmarks, and more. In some examples, a derived navigation path through the resource index can be linear or sequential, corresponding to a traditional “curriculum” model. In some examples, the derived navigation path can be non-linear, corresponding to a network navigation path.

In some examples, the system creates and/or curates a content index or a content collection by eliciting, accepting, processing and/or incorporating processing input from one or more users, such as human creators or moderators, in a crowdsourcing scenario. In some examples, the system uses a permission system with one or more tiers to control creator or moderator access to the content index. For example, a moderator can edit the content index only if the moderator is associated with specific permission tiers. Otherwise, the moderator can suggest modifications, but the editing must be approved by another moderator with the requisite permission tier(s).

In some examples, content collections can be generated by connecting node collections to each other through edge collections. A node collection can be an educational resource collection, or a concept collection. An edge collection can be a collection of edge objects that indicate relationships between concepts, between educational resources, or between concepts and educational resources. Node collections can be connected via one edge collection, or via multiple edge collections, corresponding, for example, to pairs of concepts being connected by more than one relationship. In some examples, node and edge collections can be created and/or stored via a multi-model database. The system can create a content collection by querying the multi-model database, which results in subsets of the nodes and edge collections being selectively joined to generate a navigable graph corresponding to the content collection.

In some examples, edge collections can be used to create educational experiences in the context of specific access modes. For example, edge collections can provide navigation options for a user accessing a content collection in explore node, where the navigation options correspond to candidate relationship links to follow starting from a concept being explored, and/or to candidate related concepts or content items to explore. The set of candidate concepts or content items presented to the user can be generated, personalized and/or updated over time using one more machine-learning (ML) models that take into account characteristics of the content collection and/or individual concepts and/or content items, characteristics of the user, engagement and/or assessment metrics that capture the user's experience with content items, and so forth.

In some examples, an edge collection can have one of at least three types: moderator-controlled, proprietary, or aggregate. The system can store and/or use multiple edge collections. Edge collections and node collections can be created via a collection builder module. For example, moderator-controlled edge collections are created and/or controlled by moderators, and/or contain varying degrees of relationship specificity. Moderators are prompted by the system to create a map of relationships between concepts, relationships between concepts and educational resources, or relationships between educational resources. The concepts and/or educational resources can be part of aggregate node collections accessible to the moderator, or can be part of moderator-controlled node collections. In some examples, edge collections including proprietary content, or connecting node collections including proprietary content can be implemented as proprietary collections, in the form of moderator-controlled collections affiliated with an organization, such as an employer. The organization can provide a list of associated potential administrators, and the system can elicit and receive a final choice of an administrator from the respective list.

Overall, the system enhances traditional learning methods with a indexing system that organizes educational content into multi-level indices, mapping instructional materials, such as videos and articles, to underlying concepts, which are then interconnected with respect to relationships from a predefined ontology. The system curates content collections based on input from creators or moderators in the context of a tiered permission system. The system aggregates individual collections into comprehensive knowledge graphs, which represent a default set of concepts and relationships and/or allow cross-collection navigation, providing a rich and diverse learning environment. Furthermore, the system enables a dynamic and personalized learning experience. Recommended and/or interactively constructed navigation paths through available content collections are tailored to individual users' learning goals and preferences, enabling a customized educational journey. The system's UI is designed to support various access modes, such as searching, exploring, or focusing, which cater to different learning requirements and/or objectives. For example, a learner can choose to explore related concepts freely or follow a more structured path akin to a traditional curriculum. The access modes are responsive to user interactions and/or the content is adapted presented based on the learner's profile. The learner's profile can include their educational background, goals, and previous interactions with the system. The system uses performance data from testing resources to inform the learning path. It tracks user engagement and performance, using this data to suggest the most relevant and effective resources for each concept. This ensures that learners are presented with materials that are not only conceptually linked but also proven to be effective based on the experiences of similar users. Thus, the system represents a flexible and comprehensive framework for online education, training, and general learning, where learners can navigate a curated landscape of knowledge that adapts to their unique needs, enhancing engagement and the overall learning experience.

### FIGURE SUMMARY

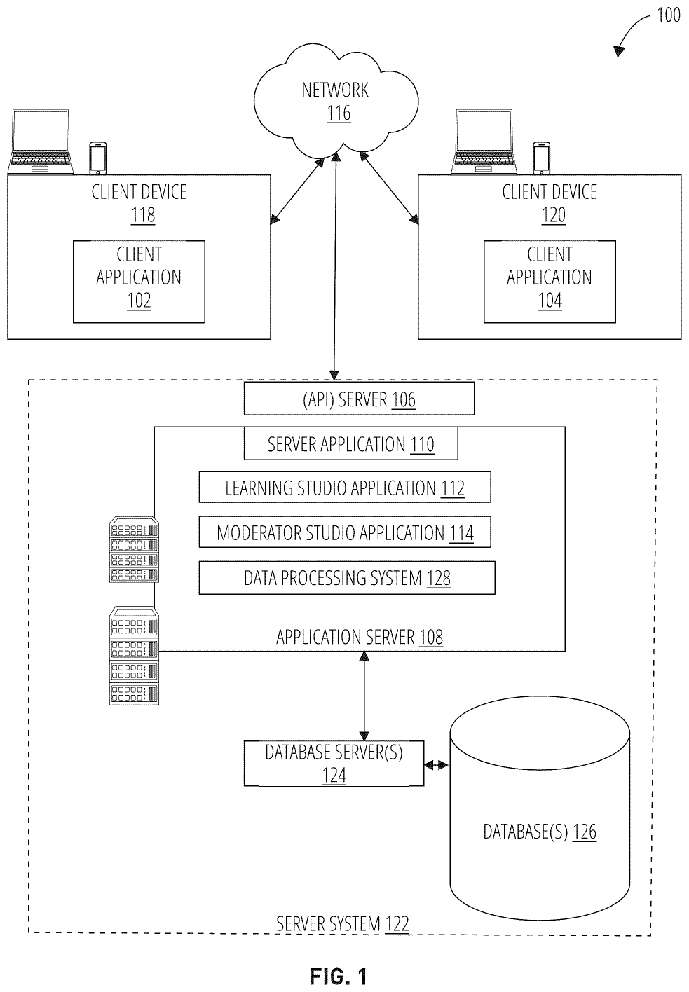

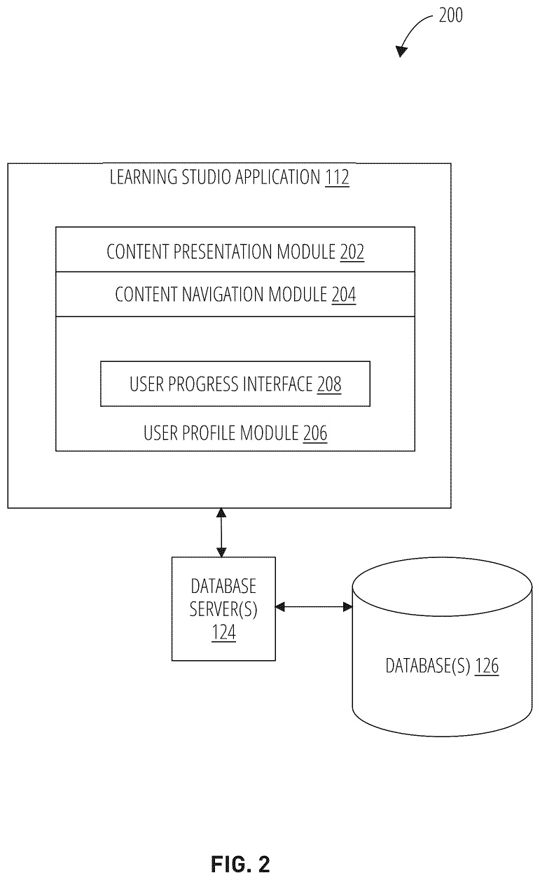

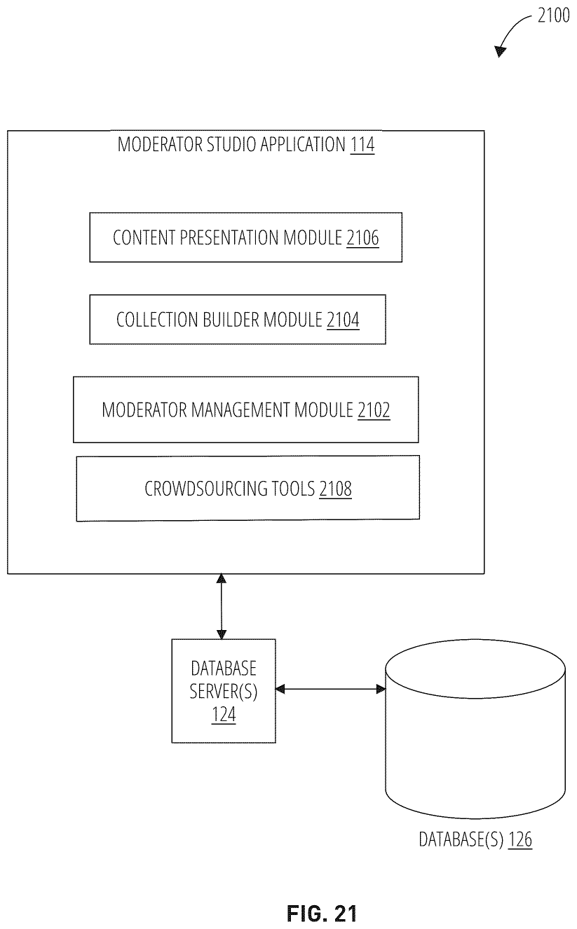

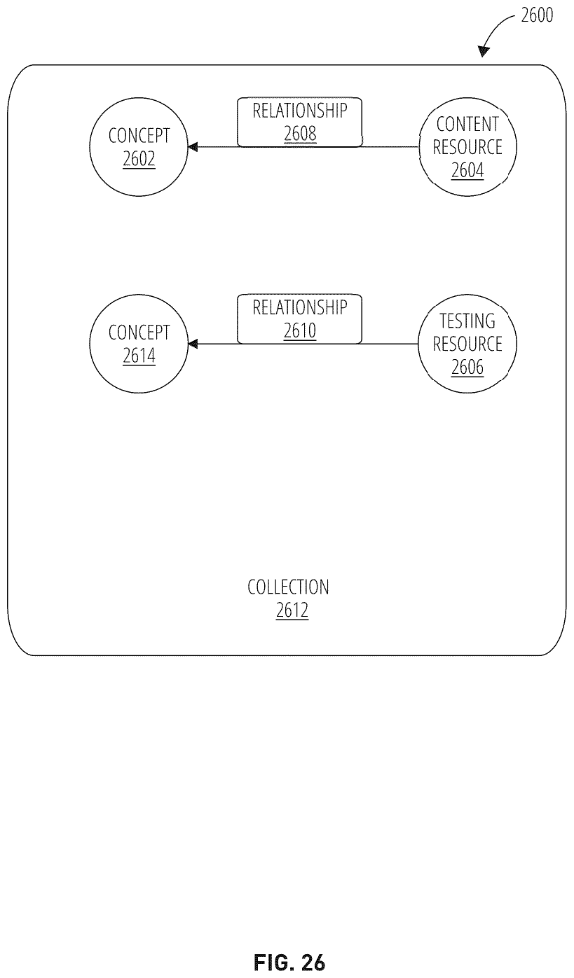

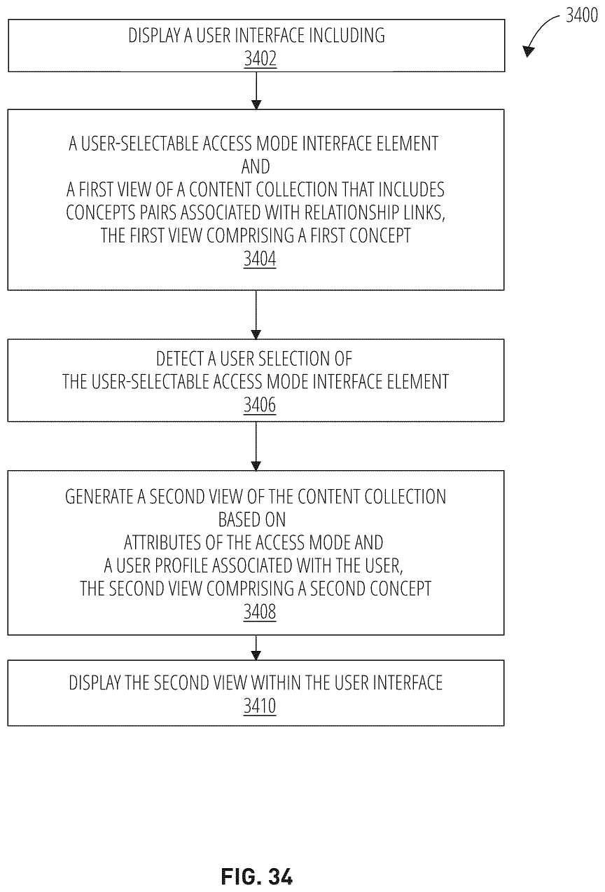

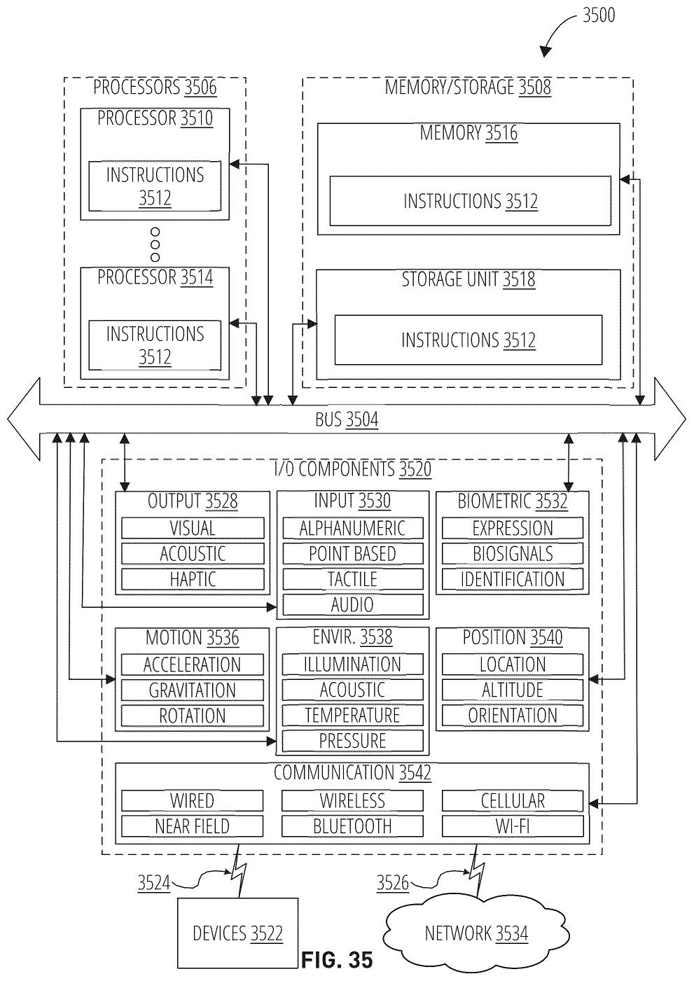

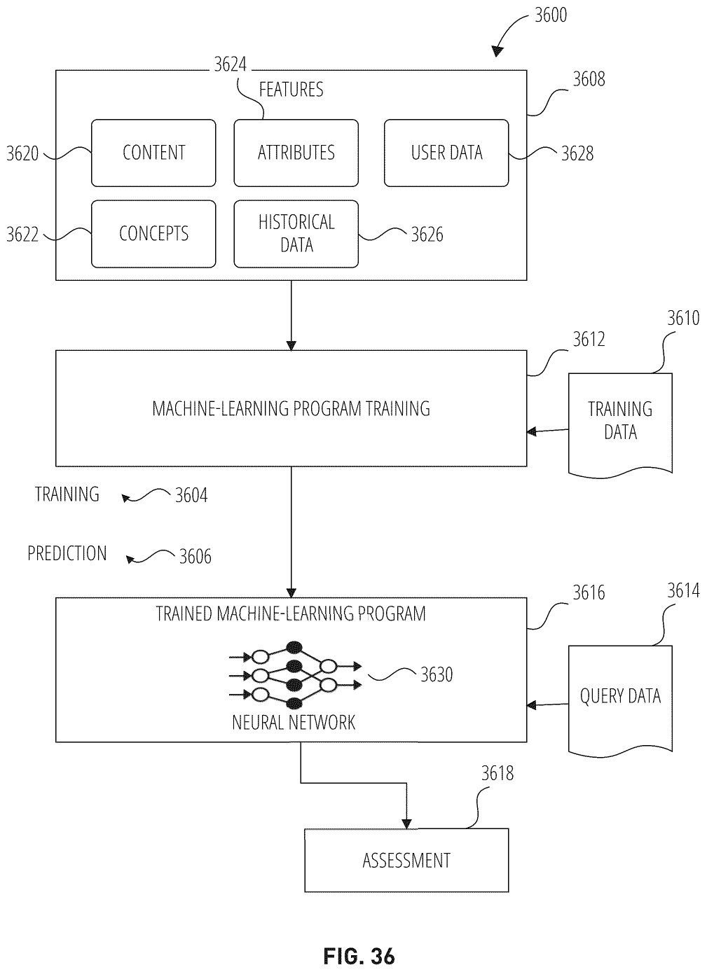

FIG. 1 illustrates an overall system architecture, including client devices, server systems, learning studio applications, moderator studio applications, API servers, application servers, database servers, and databases.
FIG. 2-FIG. 20 detail an example learning studio application, educational experiences enabled by the learning studio application, and various UIs associated with the learning studio application. The figures illustrate how educational content is automatically presented to the learners for interaction and/or navigation purposes, in the context of different learning modes. They also illustrate how the system enables users can contribute to the platform by suggesting new concepts or content.
FIG. 21-FIG. 25 detail an example moderator studio application, and various UIs enabling moderators to add new concepts, videos or testing resources, create or arrange educational programs and so forth. The figures illustrate example tools available for content curation and collection building.
FIG. 26-FIG. 33 illustrate the structure of example content collections, the relationships between concepts, between educational resources, or between concepts and educational resources, as well as the ontologies that define these relationships. The figures illustrate how individual collections are combined into larger, aggregated collection, how a navigable graph representing a content collection is generated based on node collections and edge collections.
FIG. 34 is a flowchart describing the method for accessing a content collection, including the steps taken by the system in response to user selections.
FIG. 35 shows a block diagram of the machine components, such as processors, memory/storage, and I/O components, that are capable of executing the system's instructions.
FIG. 36 illustrates a machine-learning program.

FIG. 1 is a block diagram showing an example system 100 for creating, curating and presenting a content index (or resource index). The system 100 includes one or more client device(s) (e.g., client devices 118 and 120) that host a number of applications including client applications 102 and 104.

Each client application (e.g., 102) is able to communicate and exchange data with another client application (e.g., 104) and with the server application 110 executed at the server system 122 via the network 116. The data exchanged between client applications, and between a client application (e.g., 102 or 104) and the server system 122, includes functions (e.g., commands to invoke functions) as well as payload data (e.g., text, audio, video or other multimedia data).

The server system 122 provides server-side functionality via the network 116 to client applications 102 and 104. While certain functions of the system 100 are described herein as being performed by either client application 102 and 104 or by the server system 122, it will be appreciated that the location of certain functionality either within a client application or the server system is a design choice. For example, it may be technically preferable to initially deploy certain technology and functionality within the server system 122, but to later migrate this technology and functionality to client applications 102 or 104, where there may be sufficient processing capacity.

The server system 122 supports various services and operations that are provided to client applications (e.g., 102 and 104). Such operations include transmitting data to, receiving data from, and processing data generated by the client applications. In some embodiments, this data includes, message content, device information, geolocation information, persistence conditions, social network information, sensor data, and live event information, as examples. In other embodiments, other data is used. Data exchanges within the system 100 are invoked and controlled through functions available via graphical user interfaces (GUIs) of the client application 102 and 104.

Turning now specifically to the server system 122, an Application Program Interface (API) server 106 is coupled to, and provides a programmatic interface to, an application server 108. The application server 108 is communicatively coupled to database server(s) 124, which facilitate access to one or more database(s) 126 that store data associated with data generated by client applications 102 and 104 and processed by the application server 108.

Dealing specifically with the API server 106, this server receives and transmits data (e.g., commands, and payloads) between client devices 118 and 120 and the application server 108. Specifically, the API server 106 provides a set of interfaces (e.g., routines and protocols) that can be called or queried by the client applications 102 and 104 in order to invoke functionality of the application server 108. The API server 106 exposes various functions supported by the application server 108, including account registration, login functionality, the transmission of data, via the application server 108 between client applications, the sending of data (e.g., text, images, video, geolocation data, etc.) from a client application 102 or 104 to the server application 110, and for possible access by another client application, the setting of a collection of data, the retrieval of such collections, the retrieval of data, and the location of devices within a region.

The application server 108 hosts a number of applications and subsystems, including a server application 110, a learning studio application 112, a moderator studio application 114 and a data processing system 128.

The server application 110 implements a number of data processing technologies and functions, particularly related to the accessing, creating, updating and other processing of data (e.g., content resources, content or resource indexes or knowledge graphs) by client application 102 or 104. Other processor and memory intensive processing of data may also be performed server-side by the server application 110, in view of the hardware requirements for such processing.

The learning studio application 112 implements a number of technologies and functions, particularly related to the searching, retrieving and presenting content items (or a content index) to one or more users of a client device 118 (e.g., learners) via a communication between client application 102 and the learning studio application 112 running on server system 122. Further details of the learning studio application 112 can be found at least in the detailed description of FIG. 2.

The moderator studio application 114 implements a number of technologies and functions, particularly related to the searching, retrieving and updating a content index (e.g., a content collection, a knowledge graph) by a user (e.g., content creator, moderator, educator, etc.) of a client device 120 via a communication between client application 104 and the moderator studio application 114 running on server system 122. Further details of the moderator studio application 114 can be found at least in the detailed description of FIG. 21.

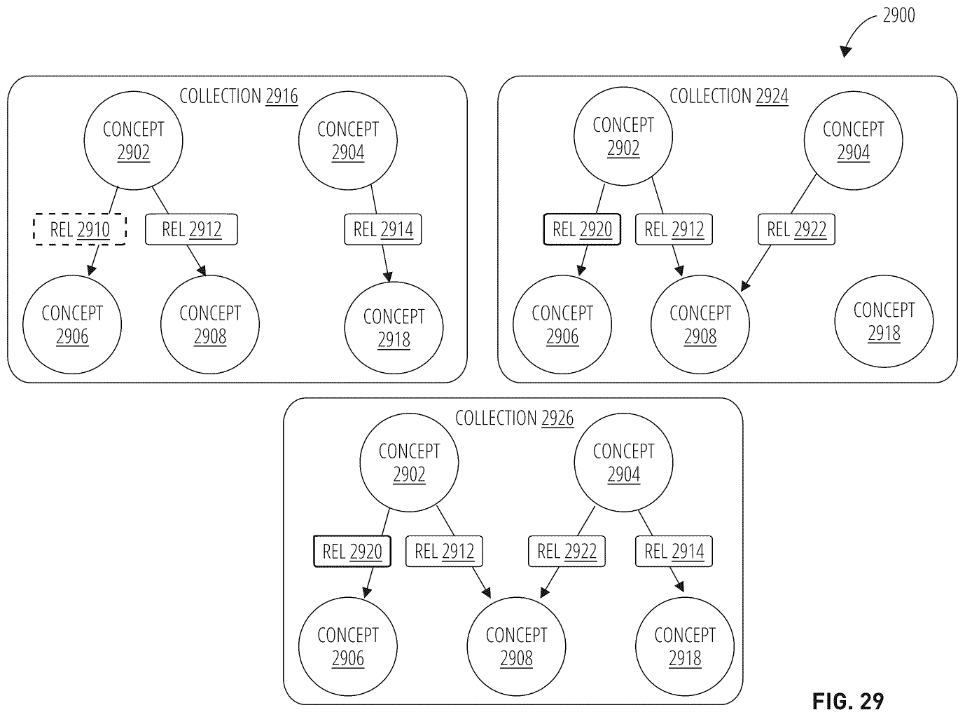

The data processing system 128 implements a number of technologies and functions, particularly related to generating, accessing, updating and aggregating data generated or processed by client applications (such as 102 or 104) and by applications and subsystems of server system 122. Further details of specific technologies and functions implemented by the data processing system 128 in connection to different types of data and data operations can be found in detailed descriptions of FIG. 2, FIG. 21, FIG. 29 and more.

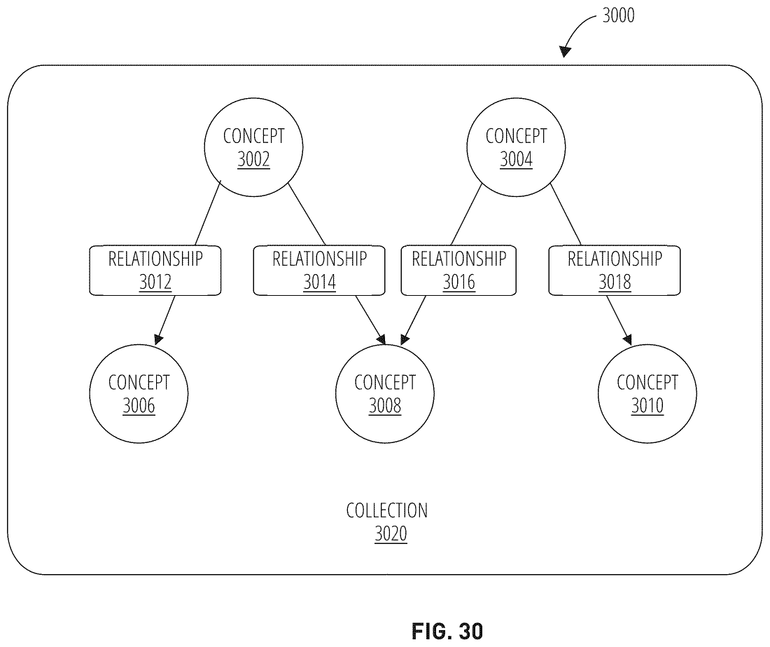

The application server 108 is communicatively coupled to one or more database server(s) 124, which facilitate access to one or more database(s) 126 storing data associated with data generated or processed by client applications 102 and 104 and one or more applications and subsystems of server system 122. One or more of the database(s) 126 are used to store content items as well as one or more content indexes or content collections (for further details, see detailed descriptions of FIG. 30, FIG. 29 and FIG. 35). One or more of the database(s) 126 can be a hypergraph database (e.g., TypeDB), a relational database (e.g., a SQL database such as MYSQL, etc.) or a non-tabular database (e.g., a NoSQL database such as MongoDB, etc.). In some examples, one or more of the database(s) 126 is a multi-model database (e.g., ArangoDB), which allows for interoperable clusters of graph, document, and key-value databases.

FIG. 2 is a block diagram illustrating a learning studio application 112, according to some examples. The learning studio application 112 includes a content presentation module 202, a content navigation module 204 and a user profile module 206. In some examples, data related to data accessed or generated by the learning studio application 112 is stored in one or more database(s) 126, via one or more database server(s) 124. In some embodiments, a learning studio application 112 can be a web application or a mobile application.

### Content Presentation Module

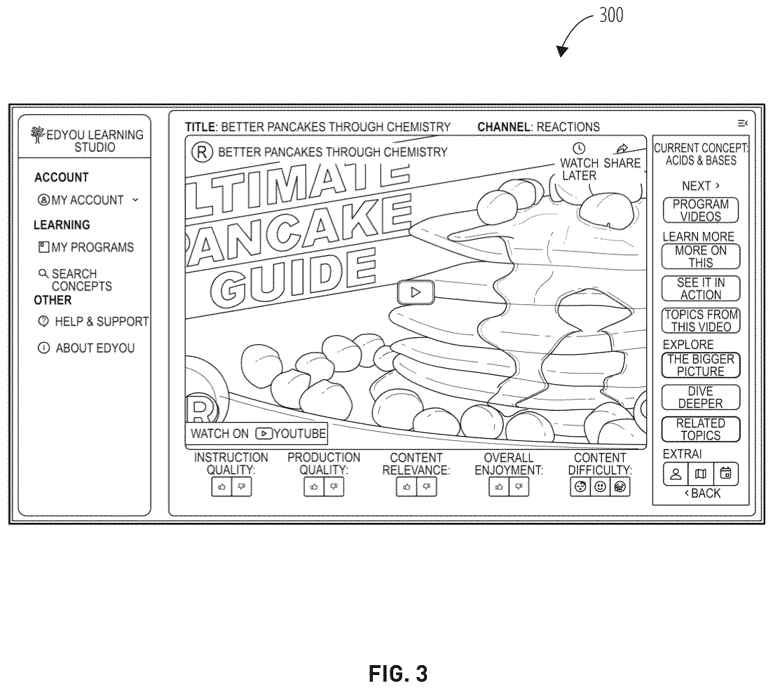

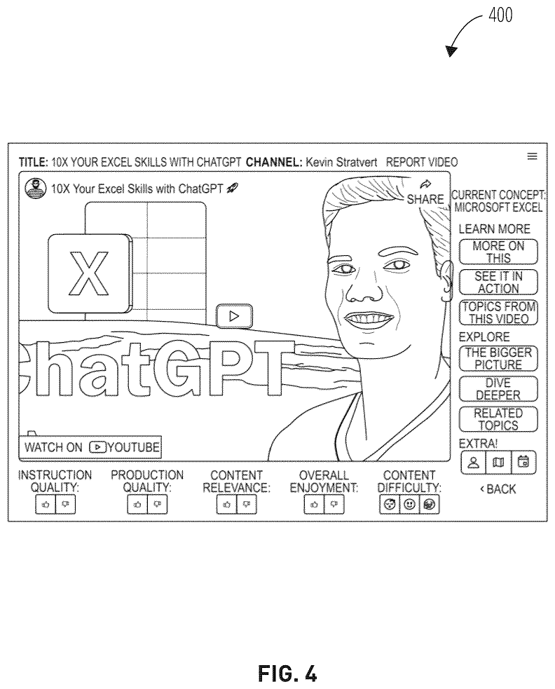

The learning studio application 112 includes a content presentation module 202 that presents concepts or content items such as learning resources or testing resources via a UI displayed by a client application 102 at client device 118 (see, e.g., at least FIG. 3 or FIG. 4). Example concepts can include core Chemistry, Math or History topics, activities such as baking or gardening, and so forth. Content items can include Wikipedia pages, YouTube videos, interactive tests, and so forth. Automatically detected selections of user-selectable interface elements from a UI associated with the content presentation module 202 are used by the content navigation module 204 to help the user navigate through content collections, as described below.

### Content Navigation Module

The learning studio application 112 includes a content navigation module 204 that implements functions and/or technologies for navigating one or more collections of concepts and content items. In some examples, the content navigation module 204 detects that a content collection including concepts and/or content items is selected, by a user, as a starting point from a list of collections. The list of collections can be displayed as part of a learning studio application 112 UI, or as part of a UI for a related application such as a marketplace collection or ecommerce store application. The learning studio application 112 can use a dialogue module to confirm a set of learning goals and preferences for a user, and/or use this data to recommend one or more collections for the user to choose amongst. The content navigation module 204 can detect that a concept and/or content item of the starting collection has been chosen as a starting concept and/or starting content item by the user.

The content navigation module 204 implements multiple access modes, such as a search mode, an explore mode, focus mode, and so forth, as described in detail below. Upon detecting a user selection of a user-selectable interface element, a particular mode is activated by the content navigation module 204. For example, detecting a user entering a query within a “Search” box” leads to the activation of the search mode. The learning studio application 112 can automatically suggest switching access modes, or default to a mode that can be overridden by automatically detected user selections. For example, the learning studio application 112 can be in “explore” mode once a starting point such as a concept or content item has been chosen by the user.

In an example, upon detecting a user's selection of a “Search” mode interface element (or equivalent) in a UI for the learning studio application 112, the content navigation module 204 enables the user to search the one or more collections of concepts and content items. In an example, the content navigation module 204 enables the user to select a concept from a concept library, and then select a learning resource to begin learning about the concept. The content navigation module 204 can then direct the user to a media viewer enabling the user to view the selected resource and/or access a navigational panel to explore related concepts and/or learning resources.

In an example, upon detecting a user's selection of an “Explore” mode interface element (or equivalent) in a UI for the learning studio application 112, the content navigation module 204 enables the user to browse one or more collections of concepts and content items. The content navigation module 204 selects and/or displays relationships between concepts, or between concepts and content items, allowing the user to select a relationship to follow with respect to a currently displayed concept or content item. Examples of relationships between concepts include BROADER_THAN, NARROWER_THAN, RELATED or SIMILAR, and so forth. Examples between concepts and content items include IS_INTEREST, IS_METHOD, and so forth. In some examples given a user-selected relationship, the learning studio application 112 presents the user with a selected and/or ranked set of concepts and/or content items of interest (see below for details). Upon detecting a user's selection of a concept and/or content item, the learning studio application 112 displays the selected concept and/or content item in a new visualization, enabling the user's continued navigation through the collection. In some examples, the content collection being explored corresponds to a navigable graph generated based on one or more node collections and edge collections, as described in FIG. 26. In this case, displayed relationships correspond to edges in an edge collection, while the candidate concepts or content items presented to the user correspond to nodes in node collections (see, e.g., FIG. 26).

Selecting and/or ranking concepts or content item recommendations can take into account a combination of content-based signals and/or user-level signals. User-level signals can include user profile information, user-level and/or user-population level interaction and/or engagement metrics for concepts, content items and collections. Engagement metrics can include the number of users or user sessions that viewed a particular video, the number of users with similar goals and/or educational background that viewed a particular video while in the same exploration mode, and so forth. Selecting and/or ranking content or concept recommendations can take into account user assessment performance after viewing content, and other measures of user interaction with content.

Content-based signals can include a mix of signals associated with content items and/or signals associated with the concepts and/or content collection. Content-based signals can include type of content item and/or educational resource, characteristics of the content item creator (experience level, domain expertise, style of instruction or created content, popularity, background, etc.), content item ratings, content item style (e.g., formal or informal, etc.), content item quality (instruction quality, production quality, overall enjoyment), content item difficulty level, content item complexity, content category information or domain information, content item availability and/or recency, characteristics of the content item delivery channel (e.g., a particular channel can offer content a user is reliably interested in) and so forth. In some examples, concept and/or relationship-level characteristics in the context of a content collection are also used for selecting and/or ranking recommendations. Such characteristics can include, for example, the weight or strength of a relationship between concepts in the context of a collection, the weight or strength of a relationship between a concept and a content item, or between content items (as detailed in FIG. 26). In some examples, concept characteristics such as knowledge domain, difficulty level, and others can be used as part of the content-based signals (see, e.g. FIG. 26 for additional examples of such characteristics).

In some examples, content-based signals are computed based on user feedback and/or system tracking of user performance after viewing a content item in the context of an active concept and/or content collection. For example, if a user downvoted one or more videos or otherwise indicated they were not relevant to a specific concept, the video would not be selected for repeat recommendations and/or would be downranked in a subsequent set of recommended resources for the user. Similarly, if a user doesn't perform well on a testing resource for a concept after viewing a video for the concept, a testing resource of a lower difficulty level could be ranked higher in a future set of recommended testing resources for the specific content. Furthermore, the video could be downranked in a future set of concept-specific recommended videos, as potentially less informative than other videos directly followed by better assessment performance.

In some examples, one or more of the content-based signals or user-based signals will be computed using artificial intelligence (AI) or machine learning (ML) techniques. For example, a difficulty level associated with a content item can be automatically computed using an unsupervised or supervised ML method. The method can use, for example, a set of (content item, difficulty level) labeled pairs and train a ML model to automatically label a new content item with the appropriate difficulty level. In some examples, the assigned levels can be automatically updated, revised and/or personalized over time by incorporating user-level feedback signals. For example, an initial set of difficulty levels can reflect a moderator view of difficulty, and can be automatically updated over time, to reflect the difficulty experienced by the learner(s) when interacting with the content. In some examples, user assessment performance can be used as a direct signal for a ML model computing and/or revising the difficulty level of a content item.

In some examples, the system 100 can use a vector database containing automatically-computed embeddings (e.g., word embeddings, image embeddings) for various educational resources. Transcripts of YouTube videos, text of web resources, and so forth, can be automatically obtained and used to compute content item-level embeddings. User-level information such as user-provided characteristics, learning goals, explored resources, user activity within the platform and so forth can be automatically embedded as well, and/or used to query to the vector database for educational resources. Relevant educational resources can then be retrieved based on one or more similarity or relevance measures taking into account content item embeddings and/or query embeddings. The content navigation module 204 can incorporate the vector database into a content recommendation system or component that is part of a framework directed to optimize user retention, engagement and/or assessment performance over time.

In some examples, the content navigation module 204 limits user exploration to one of a set of content collections, while in others, the content navigation module 204 allows the user to traverse multiple collections. In some examples, given a current concept in the context of a collection and/or a navigation path, options for follow-up recommendations are sparse. This scenario can happen when a user has navigated the collection, approaching its boundary. In such cases, navigation options and/or recommended relationships, concept and/or content items can be enabled by a default or aggregate collection and/or knowledge map. In some examples, relationships from such default exploration options can be associated with UI elements indicating their provenance is from a default content collection, rather than the active collection being explored by the user. The use of the default exploration options can be automatic and/or enabled by detecting a user selection of a corresponding UI toggle or equivalent UI element.

In some examples, upon detecting a user's selection of a focus mode element on a UI for the learning studio application 112, the content navigation module 204 restricts exploration to a sequential path through a collection. The sequential path through the collection corresponds to a linear concept progression, defining a program. As part of a program, concepts are presented in an ordered fixed sequence, established by the program creator, such as a moderator. Thus, this interaction mode corresponds to a program mode, analogous to traditional class models or paradigms.

In some examples, a program can be defined based on, or in association with, a content collection by storing a concept sequence corresponding to the program as a list of concept IDs. When the access mode is detected to be a program mode (e.g., an example of a focus mode), the content navigation module 204 presents the concepts in the sequence to the user, ushering the user through the dedicated program. If the access mode is detected to be, for example, an explore mode in the context of the specific content collection, the content navigation module 204 can present concepts based on additional relationship links, forgoing the concept sequence characterizing the program.

The learning studio application 112 uses multiple types of programs, such as concept programs, resource programs, and/or headline programs.

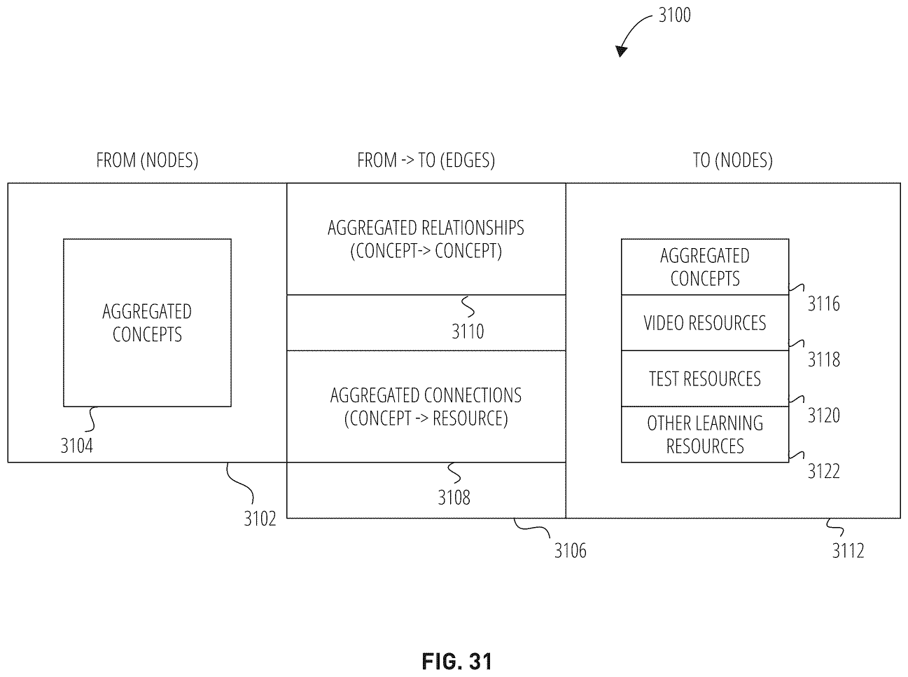

Concept programs specify the sequences of concepts to be covered. For each concept in a sequence of concepts, the content navigation module 204 presents a selected and/or ranked set of content items retrieved for example using an aggregated connections 3108 edge collection (see, e.g., FIG. 31). Upon detecting a user selection of a content items of the presented set, the content navigation module 204 can play and/or display the content item (e.g., play a video, present a Wikipedia page, etc.). The content navigation module 204 enables the user to go back to the concept progression, select one of a set of related content items (also retrieved based on the aggregated edge collection), and so forth.

The content navigation module 204 can enable a user to explore concepts outside the current concept program by presenting concepts related to one or more of the sequence concepts using an aggregated relationships 3110 edge collection (see, e.g., FIG. 31). In some examples, UI elements are added to the UI of the learning studio application 112 to enable the user to return, or “snap back,” to the program concept sequence at any time, and/or to enable the default progression through the concept sequence if so indicated by the user.

Resource programs are programs (e.g., concept programs) that additionally specify a prioritized pool of educational resources for each concept. Resource programs are useful in thematic program creation: “The Chemistry of Baking,” programs with a specific instructional bent such as “U.S. History Through the Eyes of Minorities,” programs with other categorical distinguishers, such as “The Vietnam War: By Those Who Were There.” Each concept in a resource program can be stored as a JSON object including a property that specifies an array of unique IDs indicating the educational resources to be included in the concept-associated prioritized pool. When a user navigates to a concept in the resource program via program-specific UI elements or default exploration elements, the learning studio application 112 retrieves and/or presents to the user one or more of the resources in the prioritized pool. A resource program can include multiple instances of a concept, each instance associated with a separate learning resource prioritized pool. The resources in the prioritized pool can be ranked and/or re-ranked for the specific user in a similar fashion to that described in FIG. 2 for selecting and/or ranking concept and/or content item recommendations.

Headline programs are programs that specify one learning resource per concept. This resource will be automatically selected each time the user navigates to the corresponding concept. It can be highlighted in a high-profile position atop the resource selection menus upon repeated visits to a concept, with additional options populated from the aggregated connections 3108 collection.

In an example, upon detecting a user's selection of a quiz mode or testing mode interface element in a UI for the learning studio application 112, the content navigation module 204 enables the user to engage with one or more quizzes and/or other testing resources. In some examples, the system 100 creates quizzes by soliciting and incorporating moderator or quiz creator input, in a manner similar to that of program creation. Quiz mode testing resources can include multiple choice questions, validated free response, games, and other testing resources and/or types, any of which can be dynamically rendered within a quiz viewer. Moderators can create quizzes by specifying a list of concepts to be tested and/or a number of questions N to be generated for each concept (e.g., N≥3). The system 100 can retrieve questions based on edges in an aggregated edge collection (e.g., aggregated connections 3108). For example, the respective edges connect the concepts to be tested with the testing resources represented by the questions. In some examples, the system 100 receives moderator selections of specific testing resources for each concept. In some examples, one or more questions are automatically retrieved and/or generated, for a specific learner, based on the relative difficulty of each question, learner interests and/or characteristics, and or other categorical characteristics (such as the user interests) in a manner optimized for user engagement and learning attainment. Therefore, quiz creation can be performed near real-time, based on moderator-controlled and/or approved content.

In some examples, review mode is a subtype of quiz mode. Given a program and/or a content collection being explored where the concepts in the program and/or content collection have a minimum number of available associated testing resources, the learning studio application 112 can enable the user to use the review mode. Upon detecting a user selection of the review mode, the learning studio application 112 can generate a quiz based on available testing resources. In some examples, such testing resources are connected to corresponding concepts via an aggregated connections 3108 edge collection (see, e.g., FIG. 31). In some examples, such testing resources are part of an active priority pool of testing resources—for example, in the context of a resource program, or in the context of a content collection with specified testing resources that is being traversed while in an explore mode.

In some examples, pre-testing is a subtype of quiz mode. Pre-testing dynamically generates questions associated with concepts within a particular subject domain (e.g., math), progressively presenting the learner with questions from concepts of increasingly greater difficulty. Pre-testing can establish a baseline concept attainment of a user starting to learn within a new subject domain in the context of the system 100.

In some examples, a quiz/test builder is a subtype of quiz mode, referring to a quiz generator enabling moderators to select concepts, specify the number of testing resources for each concept, and/or specify a certain number of questions by concept at various level of question difficulty. The quiz builder displays a generated test in document form. The moderator is enabled to select specific questions and finalized a set of approved questions, in the form of a test. The finalized test can be printed, or, for organizations, assigned as an assessment for a selected group of users. This functionality enables teachers to generate assessments for use in schools, or organizations to deliver a standardized assessment to group of users.

In some examples, a subtype of quiz mode refers to the ability to generate a trivia game from a list of concepts or subject domains. The generation can take place in a survival mode, which would enable the user to answer questions until they miss K questions (K is a predetermined constant). The score for the trivia game is determined by the number of correct questions answered. The generation can take place in time challenge mode, where the user can answer questions within a specified amount of time. The trivia game can supply increasingly harder questions depending on the relative difficulty of the concepts and/or relative difficulty of testing resources associated with each concepts. The trivia game can be shared with other users, or on social media websites such as Instagram, with a local leader board for each generated quiz. Missed questions can be reviewed by learners through learning resources attached to the underlying concepts.

In some examples, the learning studio application 112 can detect that a user who is in one of at least the search, explore and/or focus modes in relation to a specific concept has selected a UI element corresponding to a “check your understanding” sub-mode (or equivalent). Upon detecting such a selection, the learning studio application 112 retrieves one or more testing resources for the specific concept. In some examples, the learning studio application 112 can provide interactive UI elements enabled to indicate, upon their selection, whether the user should be presented with an additional testing resource or returned to the prior learning mode.

In some examples, the learning studio application 112 can enable other access modes and/or corresponding learning experiences for learners. For example, a daily learning mode is a mode that provides resources for periodic progression for a learner (e.g., daily, weekly, etc.) In some examples, the resources can be multiple quizzes covering a variety of topics, periodically rotated out each week for new quizzes. Quizzes can be non-personalized. The learning studio application 112 can use “mini programs” that are automatically based and/or customized based on the user's demonstrated concept interests and/or learning goals. Such mini-programs can include video, learning resource, or challenge problem of the day, selected based on each user's interests or recent progression. A daily review quiz can be generated based on concepts completed by the user over specific time horizons (i.e. 3 questions from concepts studied 3-6 months ago, 3 from concepts studied 1-3 months ago, 3 from last month, 3 from last week). User completion of daily learning experiences can be accompanied by a system-generated annotation on a calendar, a streak notification, or the delivery of prizes and/or achievements within the platforms. In some examples, user-associated organizations can recommend daily concepts for groups of users.

In some examples, the learning studio application 112 can use one or more AI agents such as large language models (LLMs), to generate and/or customize a user-specific learning experience. For example, given a LLM-powered chat interface, the learning studio application 112 can retrieve user questions such as “How do I become an astronaut?” or “What does a doctor do?”. The system 100 and/or learning studio application 112 can use the retrieved questions to automatically generate a customized program based on the user's existing concept progress. The program can comprehensively cover target concepts associated with the question and/or LLM prompt, as well as any underlying prerequisites identified via an aggregated concept map (e.g., default content collection), or an analysis of collections containing the target concepts. In some examples, the learning studio application 112 can receive additional user input after the user completes the customized program. For example, the user can provide recommendations and/or feedback with respect to the content, progression, and/or difficulty level of the material. The learning studio application 112 can update the program based on this feedback, or provide a new program automatically incorporating the user feedback. In some examples, this redesign and/or re-customization can be part of an iterative process, as the user pursues a longer-term learning goal. In

In some examples, the learning studio application 112 can receive a user selection of one or more concepts (e.g., via a search access mode). The learning studio application 112 can then generate a program or collection by identifying the shortest path from the user's existing attainment to the target concept(s) within the graph created based on the aggregated connections 3108 collection (see, e.g., FIG. 31).

### User Profile Module

The learning studio application 112 can include a user profile module 206 that tracks and displays data related to the background and characteristics of a user, as well as data related to a user's progress through and engagement with one or more content collections. A user's profile can include a user's background, salient demographic characteristics (e.g., age, location), educational goals, default or currently selected preferences with respect to the type of navigational path through a collection, browse or search history in the context of one or more collections and including both viewed concepts and educational materials, saved collections, progress and engagement indicators automatically derived with respect to one or more collections or one or more benchmarks (e.g., concept progression, program and collection completion, number of videos watched per concept, testing resource performance), and more. In some examples, the user profile module 206 can track and display data related to a user population or community in addition to data pertaining to a unique user. Such tracking determines, for example, how often users with similar educational goals to a current user have chosen a particular concept or content item to explore. In some examples, engagement and/progress information measures can include “#unique user sessions in which Baking was selected as a next concept to explore while in Exploration mode”, the frequency of automatically-detected user selection of UI elements corresponding to concepts, content items and/or content collections, and so forth.

In some examples, the user-level and/or user-population level data tracked and processed by a user profile module 206 are used to automatically generate one or more types of visualizations to be displayed to a user, for example as part of a UI displayed by the client application 102 at client device 118. The visualization can be a user dashboard, including key progress metrics or browse and search history items, and other user-related data. The visualization can be an interactive visualization of progress and performance milestones, displayed as part of a user progress interface 208. Such a visualization can correspond to a personalized, animated visualization of a tree logo growing, where different colors correspond to levels of subject coverage of the user and tree ornaments indicate performance milestones achieved by the user. The visualization can include themes, personalized icons or digital assets earned by the user by achieving milestones as specified in a system-specific directory, curated by one or more moderators. The visualization can include other gamified elements providing one or more rewards to the user upon the user achieving predetermined milestones.

In some examples, data related to data accessed or generated by the learning studio application 112 is processed by the data processing system 128 (not shown) and is stored, retrieved from or updated using one or more database(s) 126, via one or more database server(s) 124. For instance, one or more database(s) 126 can store a set or library of concepts, a set of content items or educational resources, one or more ontologies including predetermined concept-concept relationships and/or relationships between a concept and a content item, a set of content collections, and so forth. In some examples, as noted above, content collections can be implemented via a combination of edge collections and node collections, stored for example in a multi-model database 126 (e.g., ArangoDB). In some examples, one or more database(s) 126 can store regularly updated user profile, progress and engagement data for a set of users, where a subset of the user data is associated with one or more content collections. In some examples, one or more database(s) 126 can store regularly updated engagement and progress information for concepts, content items and content collection.

FIG. 3 is an illustration of a user interface (UI) 300 displayed in connection with one or more modules of a learning studio application 112, according to some examples. The UI includes elements corresponding to user account information (e.g., “My Account”), collections accessible or previously accessed by the user (“My Programs”), current learning mode (“Search” or “Search Concepts”), a featured content viewer (e.g., displaying a learning resource in the form of a video about making pancakes), a navigation panel including a current concept (e.g., “Acids and Bases”) and navigation options in the context of available content collections and the same or different navigation modes. A user can select additional content items from the same collection, for example following a sequential path through a set of collection-specific content items by selecting “Program Videos.”

The user can select the “The Bigger Picture” navigation option as part of the “Explore” navigation mode, which allows navigation through a collection using the BROADER_THAN relationship between concepts. The user can select the “Dive Deeper” option in order to follow a NARROWER_THAN concept relationship, or select the “Related Topics” option to be recommended additional related concepts. The user can select the “See it in Action” option to choose a video out of a selected and/or ranked set of videos related to the current concept via an IS_INTEREST relationship. Given a current video, such as the “Better Pancakes through Chemistry” video, the user can select the “Topics from this Video” option to explore at least one of a set of selected and/or ranked concepts related to the video. Details about the selection and/or ranking of recommended concept and/or educational resources can be found in the description of FIG. 2.

A displayed or viewed content item is associated with metadata such as its title or channel information. UI 300 includes user-selectable rating elements that allow a user to generate explicit engagement data for a content item with respect to one or more dimensions such as instruction quality, production quality, content relevance and so on. In some examples, the explicit engagement data will result in resources that are less relevant to a learner or a population of users being ranked lower in a selected and/or ranked set of recommended resources. This system functionality ensures that each learner is presented with the highly relevant and/or individualized recommendations.

Example elements in FIG. 3 can be displayed as part of the same panel, or as part of separate panels where the separate panels could be displayed at the same time, or sequentially, based on a series of user interactions with the learning studio application 112. Example interface elements can also be displayed as part of a pop-up display, or on a separate page.

FIG. 4 is an illustration of a UI 400 displayed in connection with one or more modules of a learning studio application 112, according to some examples. The displayed UI is similar to that in FIG. 3, with a learning resource being displayed in a media viewer, and a navigation panel enabled to allow the user to explore the current concept, the current learning resource, and/or navigate to a related concept and/or a related learning resource. The displayed UI showcases a few different UI elements allowing for reporting the video, and so forth.

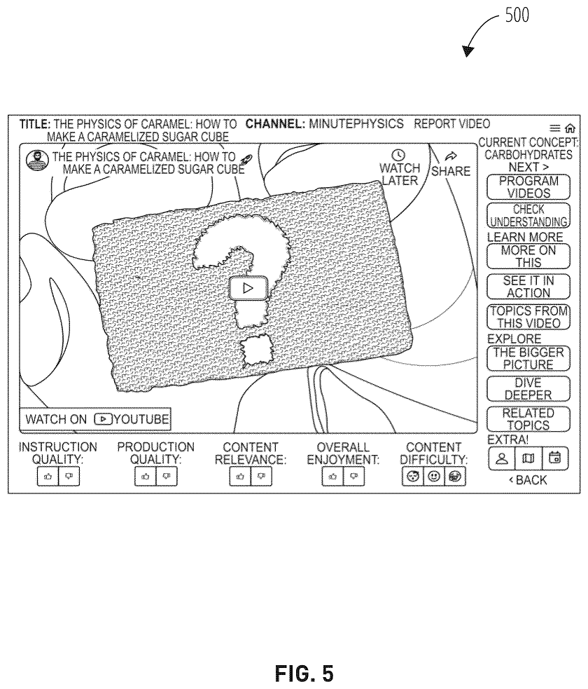

FIG. 5 is an illustration of a UI 500 displayed in connection with one or more modules of a learning studio application 112, according to some examples. UI 500 includes an example of a media viewer while a resource program is actively being worked through by the user. UI 500 includes a “Next” interactive UI element in the navigation panel. Upon detecting the user selection of this element, the learning studio application 112 retrieves the next concept in the program-associated concept sequence, for further display to the user. Upon detecting the selection of the “Program Videos” interactive UI element in the right-side navigation panel, the learning studio application 112 enables the user to access other videos in a priority pool associated with the current concept.

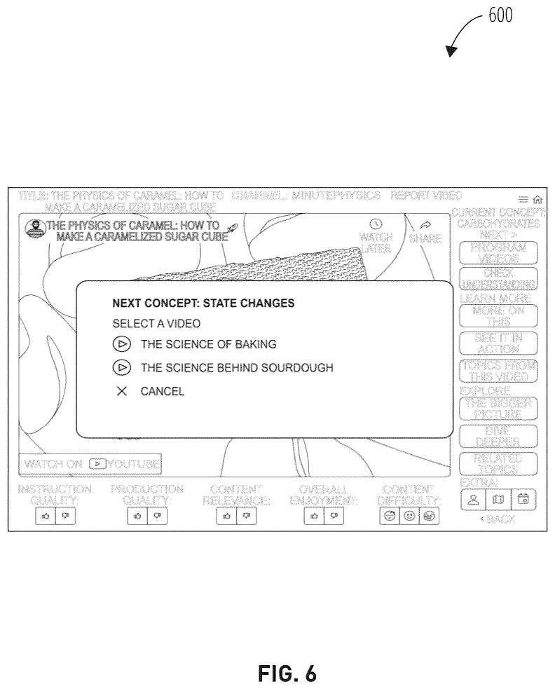

FIG. 6 is an illustration of a UI 600 displayed in connection with one or more modules of a learning studio application 112, according to some examples. Upon detecting the user selection of the “Next” UI element in the UI 500 in FIG. 5, the learning studio application 112 retrieves the next concept in the program-associated concept sequence, “State Changes”. The learning studio application 112 displays the concept together with a prompt to select among educational resources associated with the concept. Thus, FIG. 6 illustrates a prioritized pool associated with the follow-up concept in the resource program concept sequence (with respect to FIG. 5).

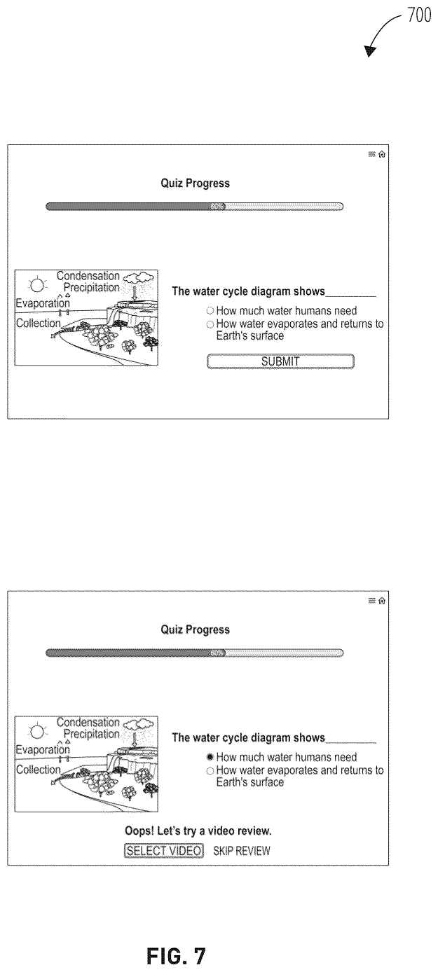

FIG. 7 is an illustration of a UI 700 displayed in connection with one or more modules of a learning studio application 112, according to some examples. FIG. 7 illustrates a quiz mode for the learning studio application 112. The top part of FIG. 7 illustrates a quiz viewer UI rendering a multiple-choice question with a picture. The quiz viewer UI can be seen as an example of a media viewer UI, or be associated with a media viewer. The quiz viewer UI includes multiple interactive navigation features. For example, when a question is incorrectly answered by the user, the quiz viewer UI prompts the user to attempt a video review for the underlying concept, as seen in the bottom part of FIG. 7. Upon receiving a selection of the UI option to navigate to such a video, an “Return to Quiz” button will be available in a corresponding media viewer used to view the video, in order to ensure the user can resume their quiz.

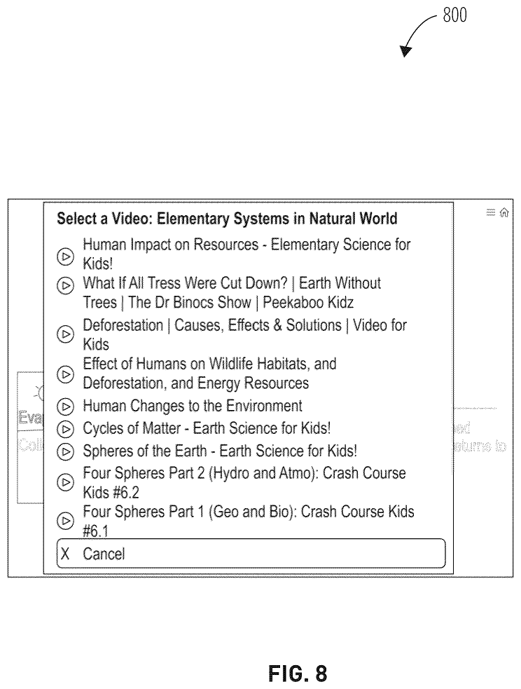

FIG. 8 is an illustration of a UI 800 displayed in connection with one or more modules of a learning studio application 112, according to some examples. FIG. 8 illustrates a quiz mode for the learning studio application 112. FIG. 8 illustrates a UI screen launched upon receiving a selection of the UI option to navigate to a video as described in FIG. 7. Upon receiving a further video selection, the learning studio application 112 enables the viewing of the selected video.

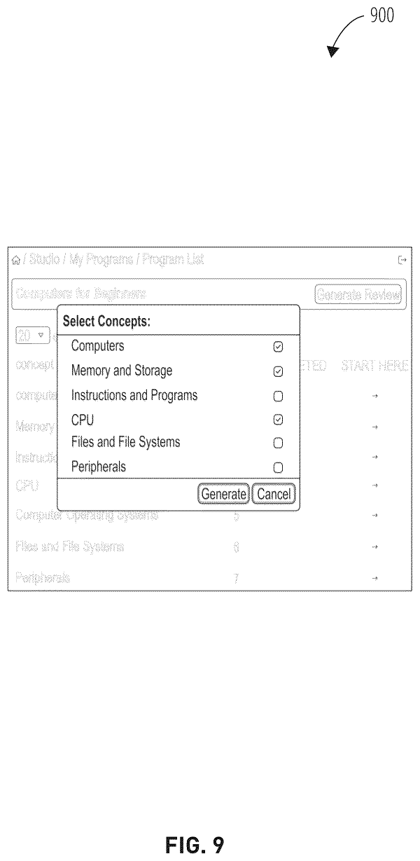

FIG. 9 is an illustration of a UI 900 displayed in connection with one or more modules of a learning studio application 112, according to some examples. FIG. 9 illustrates a review mode for the learning studio application 112. In this example, the UI screen include a menu element showcasing concepts in a “Computers for Beginners” program. Upon receiving a selection of a set of concepts, the learning studio application 112 generates a review and/or testing resource based on the selected subset of concepts.

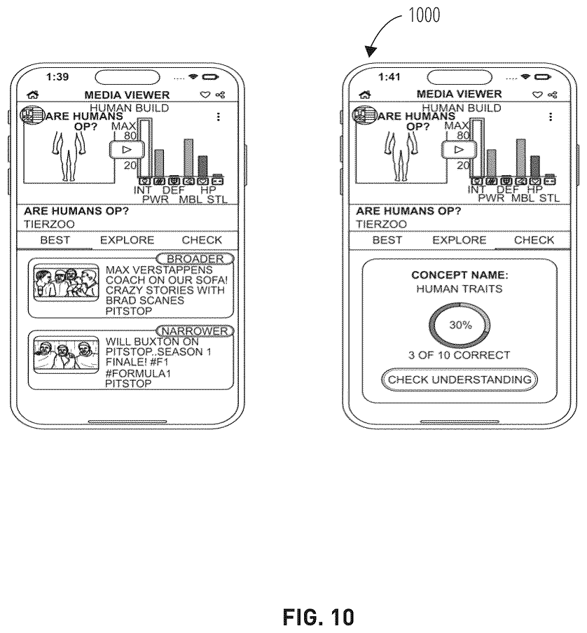

FIG. 10 is an illustration of a UI 1000 displayed in connection with one or more modules of a learning studio application 112, according to some examples. The UI presents and explores educational content, with interactive elements and/or progress tracking features.

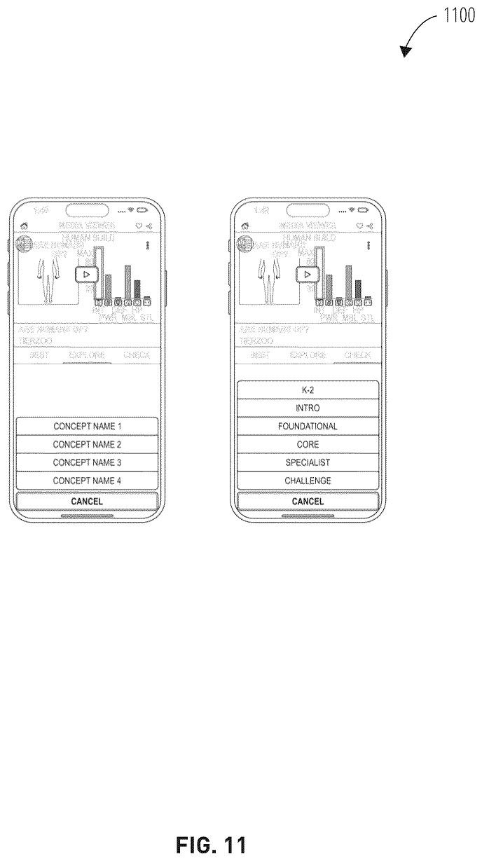

The leftmost panel illustrates a UI screen that includes a media viewer enabled to play and/or stop a chosen media item, such as a video. The UI screen includes interactive visual elements, such as “Best”, “Explore”, “Check”, and so forth. Upon detecting a user selection of such an interactive elements, the UI triggers the display of UI screens corresponding to potential follow-up user experiences, such as exploring educational content or experiences for one of a number of concepts (e.g., see FIG. 11), or checking the user's progress with respect to a learning goal (e.g., a concept such as “Human Traits”). Upon detecting a “Best” selection, the learning studio application 112 generates a list of top K (e.g., K>2) algorithmically recommended options based on user characteristics, interests, engagement and/or assessment performance.

FIG. 11 is an illustration of a UI 1100 displayed in connection with one or more modules of a learning studio application 112, according to some examples. The leftmost panel illustrates a UI screen similar to those illustrated in FIG. 10. For example, the learning studio application 112 can offer the user a selection of concepts to choose amongst, in order to continue exploring content and/or checking learning progress. “K-2”, “Intro”, “Foundational” and so forth are examples of difficulty levels associated with desired testing resources and/or levels of difficulty for the concept, in the context of selecting a “check learning” (or equivalent) option.

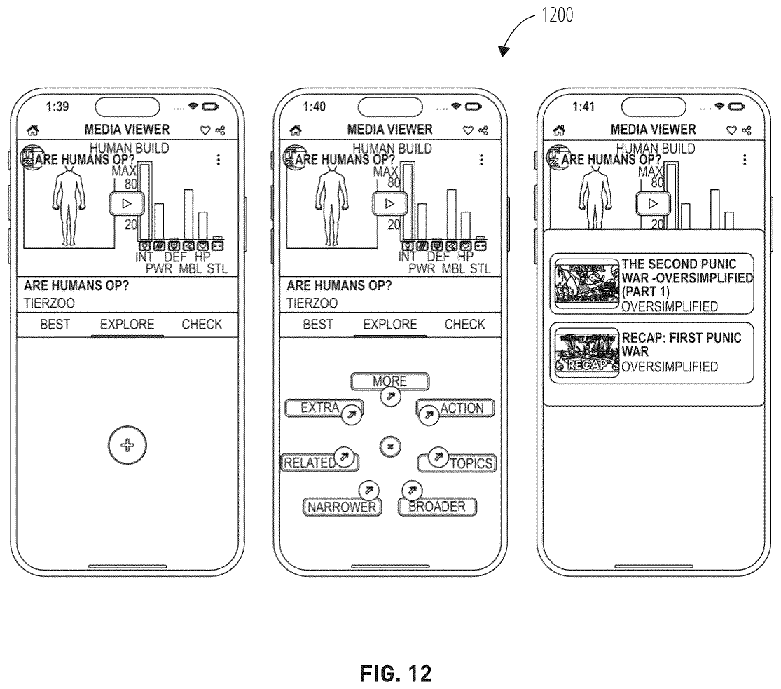

FIG. 12 is an illustration of a UI 1200 displayed in connection with one or more modules of a learning studio application 112, according to some examples.

In some examples, upon the user selecting the “Explore” option in a FIG. 10 UI screen, the learning studio application 112 UI can present the user with a choice of exploration paths. Exploration paths can include proceeding with a narrower or broader concept, a generally related next concept, and so forth. “Action” corresponds to enabling the user to choose videos attached to the current concept by an IS_INTEREST relationship, similarly to the “See It In Action” in a web version of the navigation. “Extra” corresponds to a batch of concept-level relationships, such as IS_PERSON, IS_PLACE, IS_EVENT. The learning studio application 112 lists concepts corresponding to related people, place and/or events-upon detecting a selection of one of the listed concepts, the user is prompted to choose an associated video.

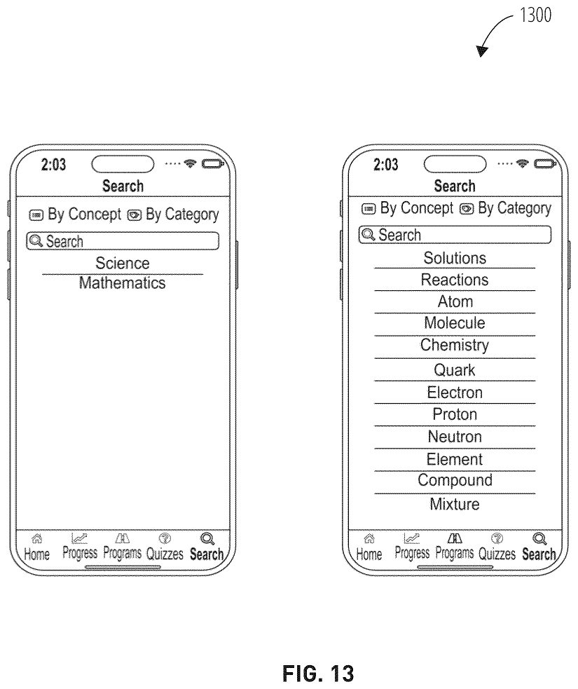

FIG. 13 is an illustration of a UI displayed in connection with one or more modules of a learning studio application 112, according to some examples. FIG. 13 illustrates a search mode for the learning studio application 112, where the learning studio application 112 enables per-category and/or per-concept search.

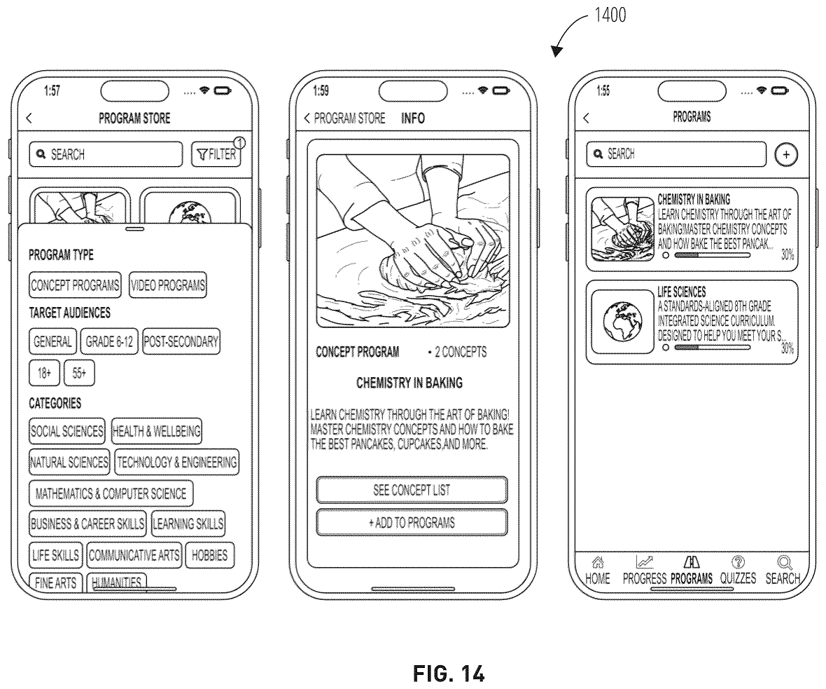

FIG. 14 is an illustration of a UI displayed in connection with one or more modules of a learning studio application 112, according to some examples. FIG. 14 illustrates a program store, containing curated programs of various types, targeting specific audiences and/or associated with various content categories. The learning studio application 112 enables browsing and/or searching in connection with the program store, as well as adding a selected program to a set of user-specific programs. For example, the rightmost panel shows a set of user-specific, or user-activated, programs, together with information about the user progress related to the programs.

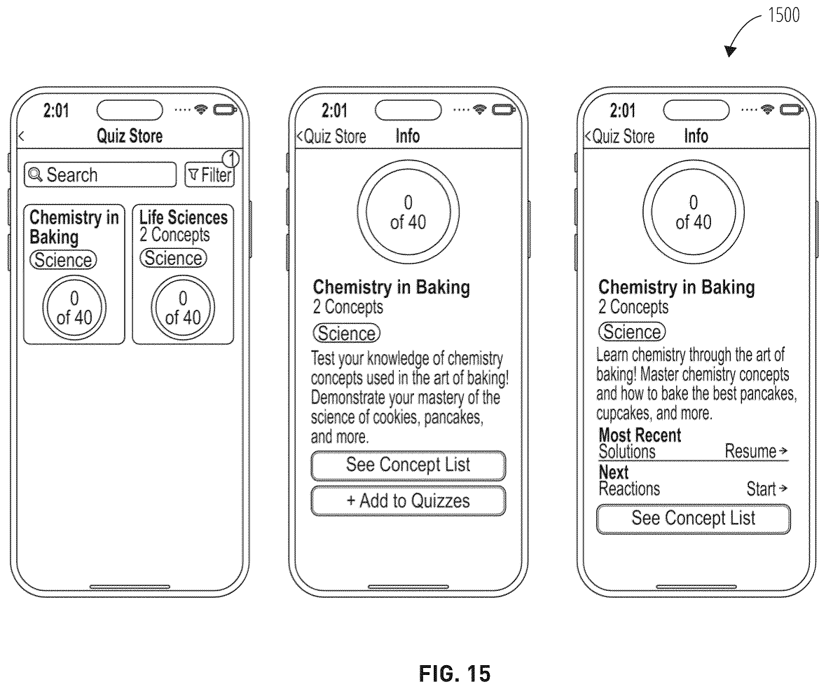

FIG. 15 is an illustration of a UI displayed in connection with one or more modules of a learning studio application 112, according to some examples. FIG. 15 illustrates a quiz store, containing quizzes associated with various content categories. The learning studio application 112 enables browsing and/or searching in connection with the quiz store, as well as adding a selected program to a set of user-specific quizzes. The learning studio application 112 also displays, for a quiz in a user's quiz library, the status of the user's progress with respect to the quiz.

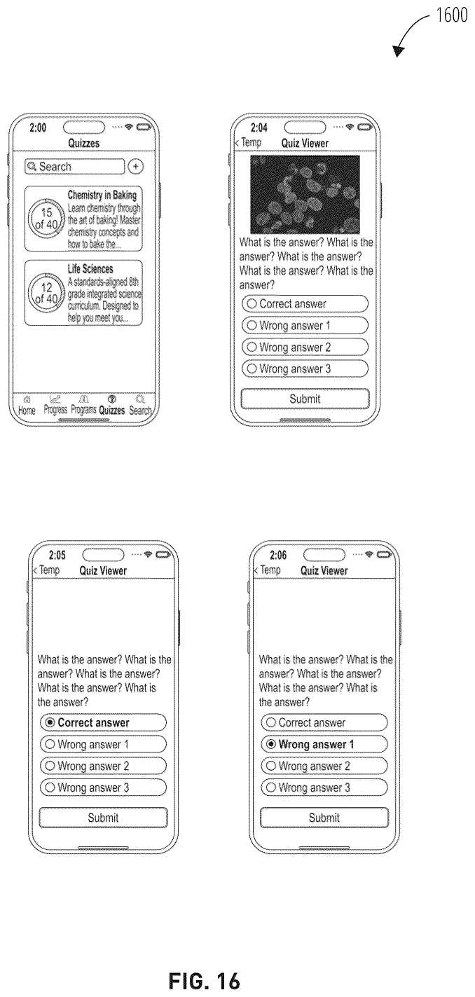

FIG. 16 is an illustration of a UI displayed in connection with one or more modules of a learning studio application 112, according to some examples. FIG. 15 illustrates UI screens corresponding to a quiz being interacted with by the user.

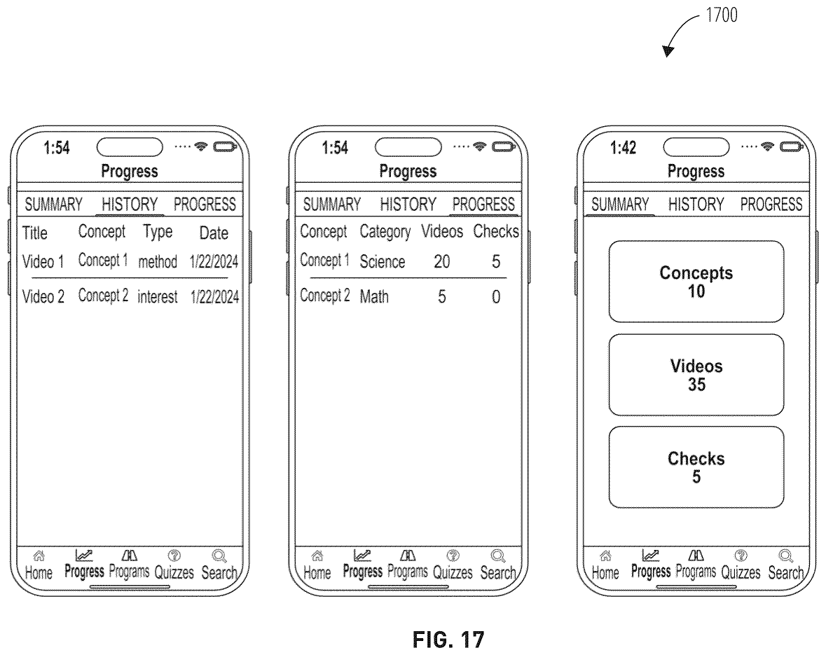

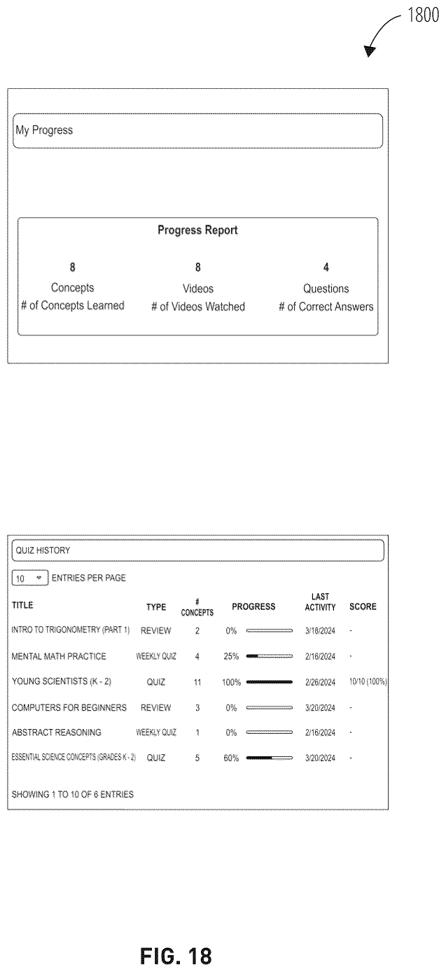

FIG. 17 is an illustration of a UI displayed in connection with one or more modules of a learning studio application 112, according to some examples. The system 100 tracks and/or showcases user progress throughout the various interactive experiences. User progress can refer to concept learning progress, as measured by the use of a learning resource associated with a concept, the progress through or completion of a testing resource for a concept within a given learning experience, and so forth. As concept learning progress is tracked for a specific concept, it is propagated through all the learning experiences that include that concept and/or is displayed for the benefit of the user. The concept learning progress can be displayed in dashboards, as seen at least in FIG. 17 and FIG. 18.

FIG. 18 is an illustration of a UI displayed in connection with one or more modules of a learning studio application 112, according to some examples. Similar to FIG. 17, FIG. 18 illustrates the displaying of user progress, which can be displayed in dashboards within a My Progress page and/or UI. For example, the top illustration in FIG. 18 showcases a summary data of resources used, while the bottom illustration in FIG. 18 displays a summary of the quiz history for the user.

In some examples, user progress and other engagement metrics such a daily activity streak, can be used to award achievements within the platform, such as badges, customizations, themes, and so forth. Such achievements can be displayed on a profile page within the learning studio, or by sharing the achievement in a pre-designed social media post. Users can notified of achievements through pop-ups. Users can be notified of achievements through pop-ups (a modal on web and a toast on mobile). Progress towards achievements can be displayed on a dedication page within the My Progress UI.

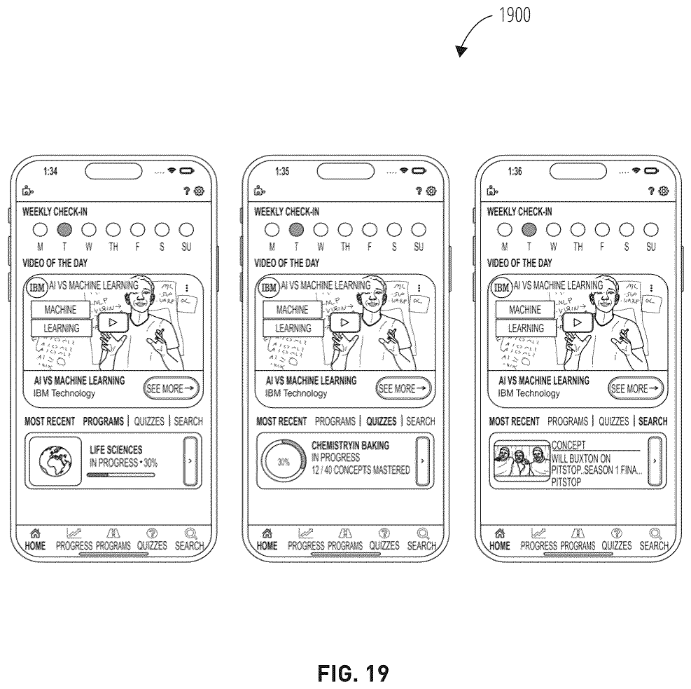

FIG. 19 is an illustration of a UI 1900 displayed in connection with one or more modules of a learning studio application 112, according to some examples. FIG. 19 illustrates a UI that provides a weekly overview of educational content and tracked user progress with respect to programs, quizzes and/or educational content consumption, highlights daily featured videos, and/or offers easy navigation to other parts of the educational platform. FIG. 19 panels showcase UI screens for a check-in UI, each displaying the week days and a highlight current day (e.g., a Tuesday). The UI screens include a recommended video of the day, as well as sections for “Most Recent,” “Programs,” “Quizzes,” a search function, and/or progress indicators for ongoing educational programs.

The first UI screen in the leftmost panel of FIG. 19 includes a partially-filled horizontal bar indicating a user progress tracker for the Life Sciences educational program, indicating the user has completed a percentage of the Life Sciences program.

The second UI screen in the middle panel of FIG. 19 includes displays a progress tracker for a program titled “Chemistry in Baking,” indicating the percentage of the program concepts worked through by the user.

The third UI screen in the rightmost panel of FIG. 19 showcases a recently searched video, and a channel name (e.g., “Pitstop”). In some examples, “Concept” would correspond to the active concept the user is working on.

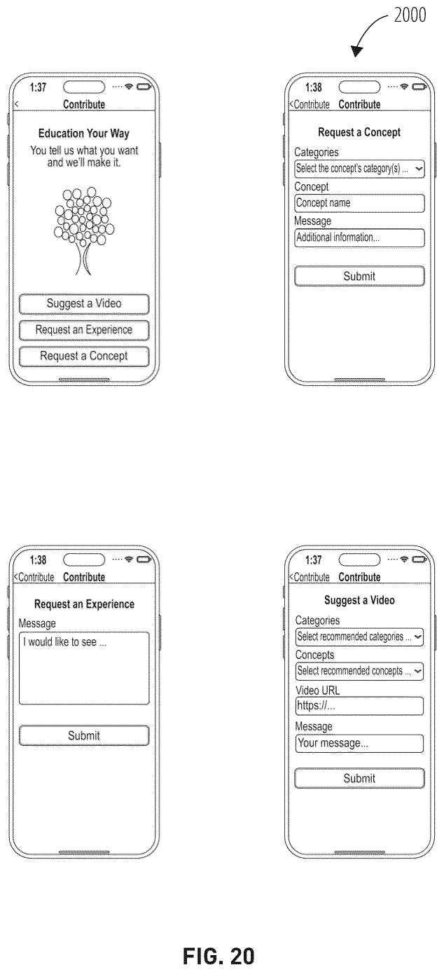

FIG. 20 is an illustration of a UI 2000 displayed in connection with one or more modules of a learning studio application 112, according to some examples. FIG. 20 illustrates a UI that encourages user engagement and content contribution. FIG. 20 illustrates multiple panels, as described below.

The first panel in FIG. 20 presents a first “Contribute” UI screen including interactive visual elements enabled to be selected by the users. Upon the learning studio application 112 detecting such a selection, the UI triggers the display of one of multiple follow-up screens, enabling users to request a concept, request an experience, or request a video.

The second panel presents a second UI screen that allows users to “Request a Concept.” The screen includes: a) an interactive element that, upon selection, offers a pull-down menu indicating choices of concept categories; b) an input field that can receive user input in the form of a concept name; c) an additional input field for receiving additional user-supplied information; d) an interactive element that, upon being selected, triggers the transmission of the category, concept name and/or supplementary information are transmitted to the learning studio application 112 and/or collection builder module 2104 of the moderator studio application 114. In some examples, the received user input detailed above can be sent to a queue accessible by moderators for the identified subject category, or to data dashboard available to moderators and used to determine user content interests.

The third panel presents a second UI screen that allows the users to “Request an Experience.” The UI screen includes a text box that can be used to receive user input describing the experience they wish to see on the platform, and/or an interactive element that, upon being selected, triggers the transmission of the user-provided description to the learning studio application 112 and/or collection builder module 2104 of the moderator studio application 114.

The fourth panel presents a fourth UI screen associated with the user suggesting a video to be added. The fourth UI screen includes interactive visual elements that can be used to receive: a) a user's selection of one of a set of recommended categories; b) a user's selection of one of a recommended concept; c) a user's selection of a video URL; and d) an additional user message. Furthermore, upon detecting the selection of a user-selectable interactive element (e.g., a “Submit” button”), the user-supplied content can be transmitted to the learning studio application 112 and/or collection builder module 2104 of the moderator studio application 114.

FIG. 21 is a block diagram illustrating a moderator studio application 114, according to some examples. The moderator studio application 114 includes a content presentation module 2106, a collection builder module 2104, a moderator management module 2102, and a crowdsourcing tools module 2108. Data related to data accessed or generated by the moderator studio application 114 is stored in one or more database(s) 126, via one or more database server(s) 124. The moderator studio application 114 can be a web application or a mobile application.

Content presentation module The moderator studio application 114 includes a content presentation module 2106, which can be used to present concepts, content items or collections to a user via a UI displayed by a client application 104 at client device 120. The content presentation module 2106 generates one or more forms used by a moderator to add or suggest content items, concepts or relationships for inclusion in one or more content collections, sets of concepts, or relationship ontologies. The content presentation module 2106 can generate and/or display a network visualization, where nodes correspond to concepts or content items and links correspond to relationships. The network visualization can be used by the collection builder module below to detect and use user input for creating and/or edit content collections.

Collection builder module A collection builder module 2104 enables moderators to take action with respect to aspects of moderator-created and/or moderator-controlled content collections. Moderators are users such as expert creators or education professionals who curate content, and/or create content collections, programs and/or educational resources to be used by learners. Moderator actions are validated and/or allowed by a permission system, the validation being based on moderator and/or content characteristics, as described in detail further below. In some examples, the collection builder module 2104 is a part of the crowdsourcing tools 2108, or separated for modularity.

Relevant aspects of content collections include concepts and/or content items, relationships between concepts, relationships between concepts and content items, a relationship ontology, and so forth. Moderator actions include, among others, content-related actions or task associated with a content collection, such as:
Designating allowable relationships included in the collection based on a subset from a relationship ontology
Adding concepts
Suggesting concepts
Adding and/or editing concept-to-concept relationships
Adding and/or editing learning resource relationships
Adding and/or editing concept-to-learning resource relationships
Adding and/or editing concept-to-testing resource or video-to-testing resource relationships
Recommending concept-to-concept relationships
Recommending concept-to-learning resource relationships
Recommending concept-to-testing resource or video-to-testing resource relationships

In an example, a moderator accesses a network visualization corresponding to a collection, where nodes correspond to concepts or content items, and links correspond to relationships between concepts, or between concepts and content items. A moderator can add or remove nodes corresponding to concepts or content items, add, remove or relabel links between nodes corresponding to relationships, and so on. Moderator-made changes can be directly applied to the underlying content collection. The changes can alternatively be stored as “suggestions,” rather than “edits,” for further review, based on permissions granted to the moderator by a permission system for the specific content. In some examples, the permission system is managed by the moderator management module 2102. Moderators can create or update part of a set of concepts, a relationship ontology or a content collection by means of another interaction mechanism, such as a resource-specific series of forms.

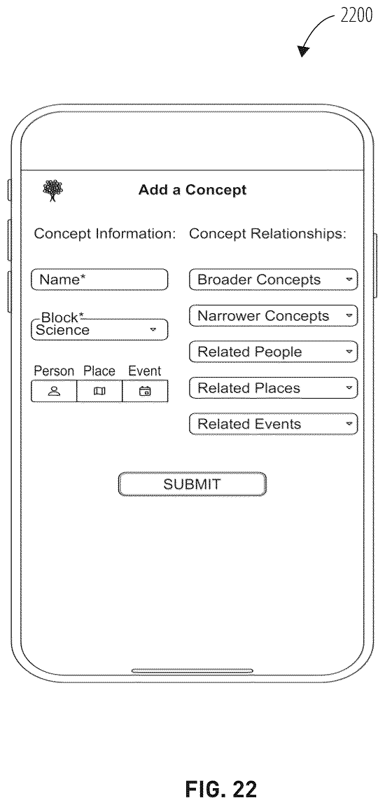

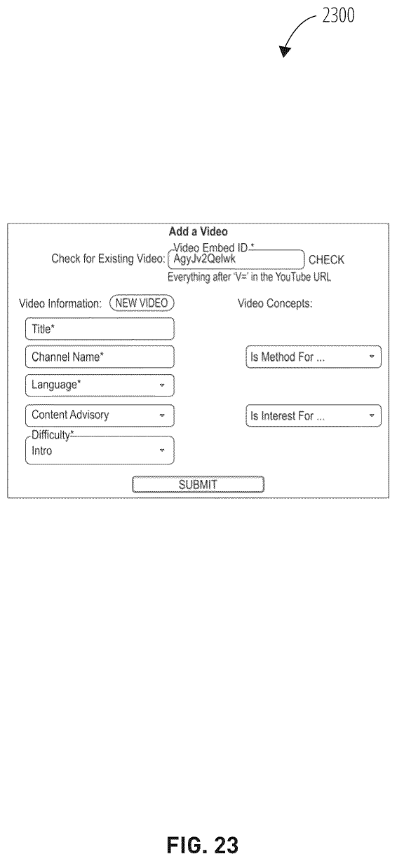

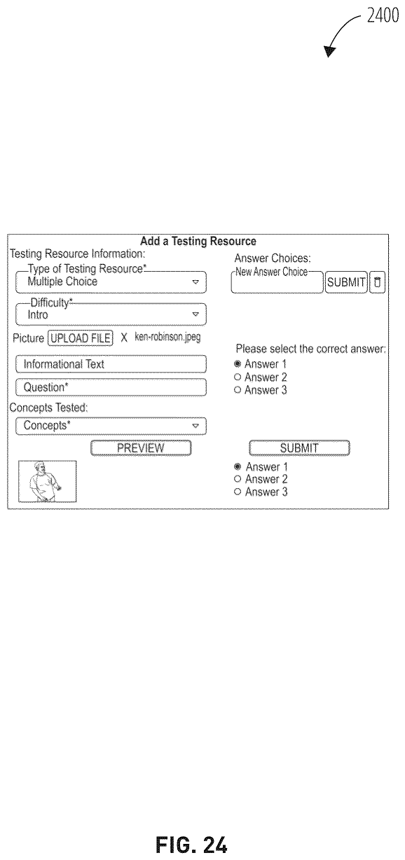

Concepts can be elicited via a dedicated UI screen, as seen at least in FIG. 22. Content items such as educational resources, in the form of learning and/or testing resources, can be elicited via dedicated UI screens, and/or displaying specific interactive forms, as seen at least in FIG. 23 or FIG. 24. Different types of educational resources require similar attribution information and/or concept connections, but slightly different technical information to source those resources via third party APIs. For example, YouTube videos need a YouTube Embed ID stored with the video node to display the resource via the YouTube Data API.

Programs and/or collections can be constructed in a series of steps or operations. A first step is acquiring concepts and/or content items as described above. A second step corresponds to acquiring connections between concepts, between concepts and/or content items, or between content items.

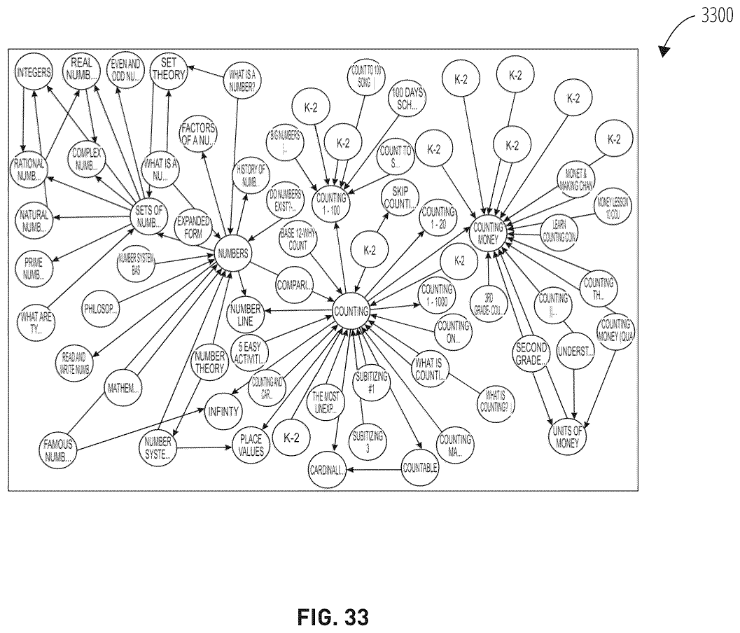

In some examples, programs and/or content collections are implemented as graphs built using node collections and edge collections, as detailed in FIG. 26. Node collections include concepts and/or content items. Edge collections include relationships. The concepts and/or content items acquired as part of the first step can be added to aggregate node collections, such as the aggregated concepts 3104, and so forth. During a second step of program and/or collection creation, the collection builder module 2104 elicits, creates and/or maintain an edge collection relating concept nodes to other concepts, and/or relating educational resources to concepts. The created edge collection can be used to power and/or generate a graph corresponding to the content collection such as the graph illustrated in FIG. 33.

In some examples, the collection builder module 2104 enables the interactive construction of a content collection as the interactive construction of such as a graph associated with an edge collection and with node collections. The collection builder module 2104 uses an interactive UI to display relevant details for each node (e.g., concept, content item) and edge (e.g., relationship). The interactive UI includes a build layer that receives input from a moderator. The moderator input takes the form of adding concept, learning resource and/or testing resource nodes from moderator-controlled node collections, and/or relationships between the nodes. The build layer displays a selection of relationships from a relationship ontology, allowing the moderator to select them for specific pairs of nodes. The relationships can be stored edges in an edge collection, as discussed above. The build layer can be powered by a form and/or UX element, such as a wheel menu, displayed directly on the interface of the graph being constructed. The build layer can publish changes to the displayed visualization, and/or generate a data object in a form appropriate for eventual data storage in database(s) 126. Upon making all desired changes, the moderator could then publish the list of changes made in the visualization to the database(s) 126, to implement those changes for users. In some examples, libraries used to interactively build the graph can include Cytoscape.js, ReactFlow, and so forth.

### Moderator Management Module

In some examples, a moderator management module 2102 manages a set of permissions for moderators with respect to an aspect of a content collection, and to an operation or action to be executed by the moderator. For example, the moderator management module 2102 can manage a set of permissions for moderators with respect to edge collections and/or node collections used to implement content collections, as detailed in FIG. 26.

The moderator management module 2102 can maintain a tiered moderation system, consisting of different crowdsourcing permission levels for each tier. For example, a tier 0 (or “any user”) moderator can suggest the inclusion of content items in a content collection. A tier 1 moderator can suggest changes to relationship links in a collection, additions to collections (or programs), or public collection snippets. A tier 1 moderator can approve the inclusion of content items by tier 0 moderators, directly link videos to concepts, edit programs, or invite other tier 1 or higher tier moderators to edit a collection created/owned by the tier 1 moderator. A tier 2 moderator can suggest concepts or core educational categories, review and approve suggested relationship link changes, additions to programs and/or public collection snippets suggested by lower tier moderators. A tier 2 moderator can directly add and edit collections and/or programs, as well as invite moderators of tier 2 or higher tier to add to a created or owned collection. A tier 3 moderator can add and edit a dictionary of concepts to be used in collections, and/or set of core educational categories. A tier 3 moderator review and/or approve concepts and categories suggested by lower tier moderators. In some examples, moderator permissions are restricted by concept subject domains. Such restrictions can be implemented via JSON concept lists, optionally specifying an associated difficulty level for each concept. Thus, the system 100 can avoid scenarios such as a moderator for Intro Chemistry curating resources for a Chemistry learning experience targeted at post-graduate students. In some examples, a moderator is thus associated with a set of permission tiers, each tier corresponding to the moderator's capabilities to add and/or edit and/or create content within a specific knowledge domain and/or one or more collections.

In one example, content collections are implemented based on node collections and/or edge collections. As detailed in FIG. 26, edge collections can include moderator-controlled edge collections containing edges representing relationships of varying specificity. The collection builder module 2104 can prompt a moderator to add create/or edit relationships between concepts, and/or relationships between content items and concepts, and/or between content items. The moderator actions are allowed and/or validated by a permission system such as the one described above. In some examples, a moderator-controlled collection is controlled by a community of moderators, rather than individuals. A founding moderator can be the administrator of the collection, and/or invite moderators at different permission tiers to contribute to the collection. For example, the moderator management module 2102 can enable the administrator to designate tier 3 moderators to add concepts, to invite tier 2 moderators to add and/or edit relationships between concepts, and tier 1 moderators to connect resources to concepts, as detailed above. The moderator management module 2102 can enable the administrator to create custom moderator tiers, each tier associated with set of powers pertaining to the moderator-controlled edge collection, including but not limited to:
Inviting and approving moderators of each created tier
Enabling moderators to perform content tasks related to the content collection (as detailed above).
Rights to view summary data for aggregate user performance and usage of the collection
Reviewing reported moderator behavior
Specifying whether the moderator-controlled edge collection allows concept-to-learning resource or concept-to-testing resource relationships
Responding to user content reports with respect to lack of concept fit, content advisory issues, and so forth.
Specifying content advisory filters for includable content
Changing the collection-associated data and/or metadata published in a learning experience store. The data or metadata include the collection description, a card image, and so forth.

In some examples, a crowdsourcing tools module 2108 refers to a variety of tools and/or forms used for the above functions, in addition to or in combination to the collection builder module 2104. Examples of such forms or interfaces can be seen throughout the specification.

In some examples, created or updated content collections, concept sets, or relationship ontologies are stored in database(s) 126, via an interaction between the moderator studio application 114 and one or more database server(s) 124. As noted above, content collections can be implemented via a combination of edge collections and node collections, stored for example in a multi-model database (e.g., ArangoDB).

FIG. 22 is an illustration of a UI 2200 for curating content collections, according to some examples. UI 2200 corresponds to a concept submission form enabled to allow a user to add a new concept to a concept library or to a collection. User-selectable fields correspond to a concept name and/or general category (e.g., “Science”). The user can select relationships between the suggested concept and one or more of other concepts in a concept library or collection. The user can label the suggested added concept with one or more types, such as Person, Place, Event, and so forth. The user submits the added concept to be added, reviewed and/or allowed, depending on the permission system data for the specific user and/or for the collection or concept library. For example, the user may only have permission to suggest a concept for further review, or can directly add it. In some examples, the user is a moderator. In some examples, the user can be a learner, in which case the user can only suggest the concept and/or associated information for further review.

FIG. 23 is an illustration of a UI 2300 for curating content collections, according to some examples. The displayed UI screen corresponds to a form for adding a video, with a mixture of interactive UI elements. For example, the drop-down menus on the right side of the form connect to a searchable list of entries in an aggregate node collection, such as a list of concepts. Upon receiving a selection of an entry of the displayed entries, the system 100, via the collection builder module 2104, creates a relationship between the video and a selected concept. The relationship can be added to an edge collection and/or reviewed or approved before being added to the edge collection, depending on permission system data for the current moderator (see, e.g., FIG. 21).

FIG. 24 is an illustration of a UI 2400 for curating content collections, according to some examples. The displayed UI screen corresponds to a testing resource form for multiple choice questions, with a variety of interactive UI elements that control the type of input received from the user in order to configure the testing resource and/or link it to other resources and/or concepts in a content collection. UI screens for other testing resources require a variety of formats, depending on the method for inputting the user answer and the types of UI elements needed to display the testing materials. For example, testing resources can be multiple choice questions, multiple-multiple choice questions, validated short answer, and so forth. Types of UI elements for testing material displays can include a picture, text, and/or video, and so forth.

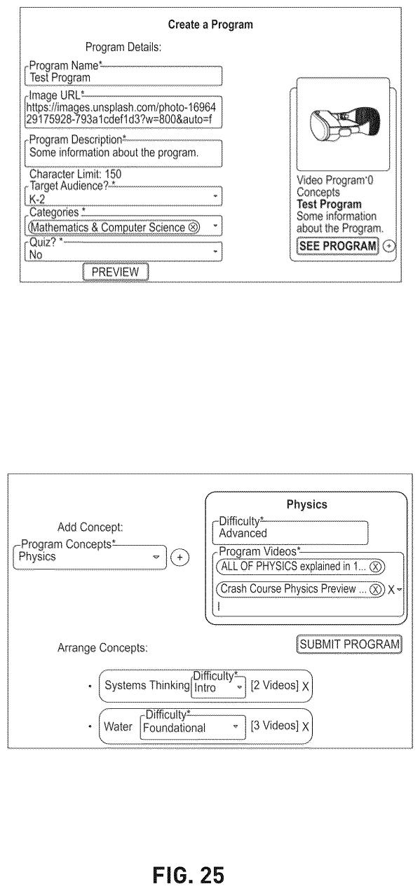

FIG. 25 is an illustration of a UI 2500 for curating content collections, according to some examples. The displayed UI screen corresponds to a program creation form. Program creation can include multiple steps. A first step includes receiving identifying information relevant to the generating UI elements describing the program (see top panel in FIG. 25). Such UI elements will be displayed in a program store, showcasing the created program. A second step receiving the ordering of concepts, the difficulty level at which the concept should be addressed, videos that should be included in a priority pool for each concept, and so forth (see, e.g., the bottom panel of FIG. 25). In some examples, UI screen(s) similar to those in FIG. 25 can be used for creating quizzes and/or testing resources.

FIG. 26 is a block diagram illustrating a partial view 2600 of a collection, according to some examples, as stored in database(s) 126. FIG. 26 illustrates an example collection 2612 that includes concept 2602 (connected to content resource 2604 by means of a relationship 2608) and concept 2614 (connected to testing resource 2606) by means of a relationship 2610. Example collection 2612 can be stored in a database 126.

### Collections

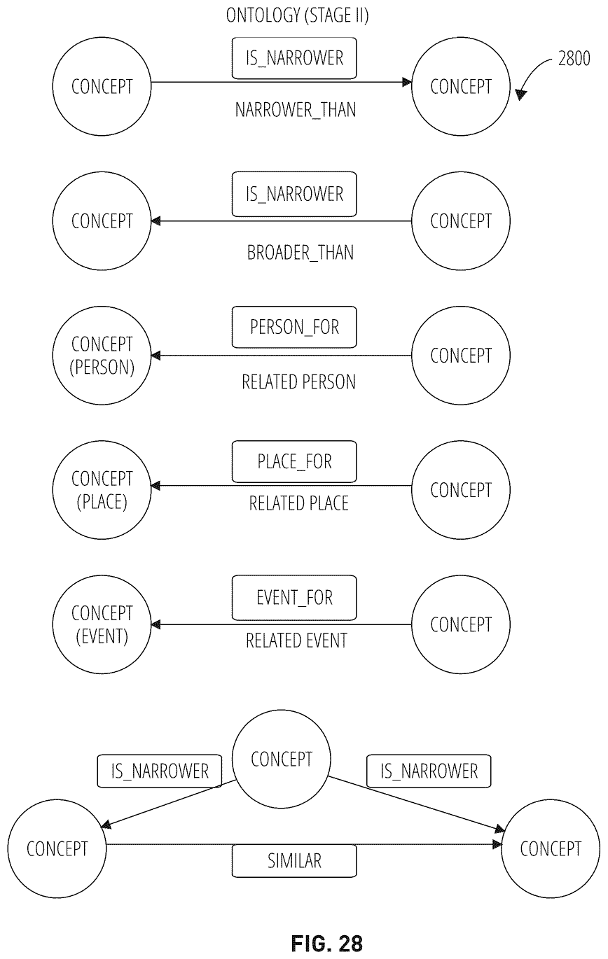

In some examples, a content collection can include concepts and/or content items. Throughout this description, collections refer to content collections. Content items are educational resources such as learning resources, testing resources, and so forth, but other content items can be used as well. Concepts are connected to content items and/or to other concepts using relationships from one or more ontologies (see, e.g. FIG. 28). Content items can also be connected using relationships of the one or more ontologies. Concepts and/or content items have a variety of characteristics and/or metadata, such as category, knowledge domain, complexity, difficulty level, centrality or relative importance in the collection user-provided feedback with respect to engagement/difficulty, and so forth. The characteristics and/or metadata can be provided by moderators, sourced from third-party APIs, or automatically determined, using ML models and/or other automatic techniques. For example, a concept's difficulty level can be calculated based on the length of the path from the concept to a high-level subject concept node in a collection (e.g., Mathematics), where the path includes IS_NARROWER edges or links. The difficulty level can be estimated using a trained ML model provided with a labeled training set of (concept, difficulty level) pair. Alternatively, the difficulty level for the concept can be determined as a function of the difficulty levels associated with the testing resources associated with the concept, and/or the average user performance on the testing resources over a population of users. The difficulty level can be determined using a combination of the above techniques as well as others. In some examples, properties like concept centrality and/or importance in the collection can be determined using graph structure analysis techniques (e.g., PageRank-type algorithms, etc.), can be automatically determined based on aggregating information about relative coverage of the concept in a pool of resources, across a set of programs for a specific domain, and so forth. In some examples, the characteristics and/or metadata of concepts and/or content items are adapted, for example using ML techniques, for a population of users or for a specific user. The respective adaptation is based on at least tracked engagement and/or assessment data reflecting a user's experience with the concepts and/or content items in the context of the user's pursuit of particular learning goals.

Relationships can have varied specificity: for example PERSON_FOR is a subtype of RELATED_PERSON, and so forth. A content collection can also include weights associated with one or more of the respective relationships. Given a concept library, a collection can include a subset of the concepts in the concept library, linked by concept-level relationships and connected to educational resources by concept-resource relationships. An example collection can have one or more owner, and one or more contributor (see, e.g. FIG. 21).

Given a concept library, multiple collections can include partially or fully overlapping sets of concepts, and/or partially and fully overlapping sets of educational resources, while including only partially overlapping (or non-overlapping) sets of relationships among concepts or between concepts and educational resources). For instance, different moderators or content creators can have different perceptions of, or pedagogical goals related to, the same set of concepts or topics related to a general theme (e.g., a moderator may be interested in supporting a teaching flow starting with low-level concepts/examples and moving to showcasing broader principles in the context of broader concepts, while another may be interested in starting with the broader concepts and moving to the narrower topics/subtopics). Furthermore, different moderators or content creators can have different views on how specific resources relate (or not) to a given concept (e.g., they may disagree as to whether a particular YouTube video is of interest to a concept, or whether an interactive quiz effectively assesses a user's understanding of a given concept).

Given a concept library, a full collection can include all the concepts in the concept library, a set of relationships connecting included concepts, as well as all educational resources, where an educational resource is connected to at least one concept in the library. In some examples, a full collection can be a default content collection, corresponding to a default knowledge graph, or to a full knowledge map.

Educational resources, such as content resources 2604 or testing resources 2606, can include videos (e.g., YouTube or Vimeo videos), text (e.g., Wikipedia pages, independent wiki pages, eBooks, surveys, Markdown text files, manuals/textbooks or other expert-authored content), applications (e.g., Web applications, games, surveys, interactive exams or quizzes, multiple-choice questions apps), multimodal content, and so forth. Educational resources can be internally sourced by having authorized creators create and upload it to the server system 122. Educational resources can be externally sourced by linking or uploading external content (e.g., Wikipedia pages, YouTube, Wikipedia, Vimeo, independent wikis, eBooks, web applications, etc.) to the server system 122, if permitted by the content license (e.g., if the content is licensed for commercial use). The linking or uploading of such resources can be done by moderators. Educational resources can be reference or general content resources 2604 (e.g., a Wikipedia page on acids and/or bases), or testing resources 2606 (e.g., an expert-authored quiz for testing a user's knowledge of acids and/or bases). Externally stored content can be served to the client application through a variety of third-party APIs, often maintained by the source organization itself (for example, the YouTube Data API).

A relationship 2608 between an educational resource (e.g., a content resource 2604 or a testing resource 2606) and a concept 2602 can have one or more types as defined by an ontology. Example relationship types include IS_METHOD, IS_INTEREST, IS_TEST, and so forth. For example, a video illustrating how to bake pancakes can be connected to a Pancakes concept using an IS_METHOD relationship. In an example, a video on the chemistry of baking pancakes can be connected to a Mixtures concept via an IS_INTEREST method. A Wikipedia page on the solar system can be connected to a Solar System concept using an IS_INTEREST relationship, or, if it is focused on various physical phenomena and/or mechanics of the solar system, via an IS_METHOD relationship. A testing resource such as an interactive exam on circular and rotational motion is connected to a Rotational Motion concept via an IS_TEST relationship, and so forth.

In some examples, relationships (e.g., a relationship edges) between educational resources (e.g., content resource 2604) and concepts (e.g., concept 2602) in the context of a particular collection (e.g., collection 2612) have one or more associated weights. Example weights can correspond to moderator-supplied values, representing assessment indicators of how strong a particular relationship is between concepts, confidence indicators corresponding to how confident a moderator is in assessing a particular relationship, and so forth. Example weights can correspond to values of engagement and performance metrics automatically derived based at least in part on user interaction with the respective collection. Such metrics can include a normalized number of unique users or sessions for which a particular resource of the set of presented resources was selected given a concept, a concept-resource relationship type and a set of presented and/or ranked potential resources in the context of the relationship type. Relationship weights can be updated periodically and/or using a time-based schedule such as daily updates/weekly updates/etc. Relationship weights can be updated based on one or more triggering event. Relationship weights can be computed and/or updated based on one or more unsupervised or supervised ML algorithms.

In some examples, collections including concepts, educational and/or relationships between concepts can be seen as hypergraph n-ary relationships and can be stored in one or more hypergraph database(s) 126 (e.g., TypeDB).

In some examples, collections can be associated with programs that follow a linear concept progression, which can be stored in the same database as a collection, or separately in a NoSQL or SQL database.

Content Collections with Node and Edge Collections

In some examples, content collections can be generated by connecting node collections to each other through edge collections. A node collection can be an educational resource collection, or a concept collection. Nodes can be represented, for example, by JSON objects. An edge collection can be a collection of edge objects that indicate relationships between concepts, between educational resources, or between concepts and educational resources. Edges can be represented, for example, by structured JSON objects detailing relationships between pairs of nodes. In some examples, each edge an associated “FROM” field and “TO” field, indicating the direction of the relationship between the pair of nodes. Node collections can be specified as “FROM” collections and/or “TO” collections. Node collections can be connected via one edge collection, or via multiple edge collections (e.g., corresponding, for example, to pairs of concepts being connected by more than one relationship). A generated content collection (e.g., knowledge graph) can, therefore, be a multigraph.

Node and edge collections can be created and/or stored via a multi-model database (e.g., ArangoDB). The system 100 can create content collections by querying the multi-model database: subsets of the nodes and edge collections are selectively joined to generate a desired content collection, represented as a navigable graph database. Node and edge collections can be assigned credential protections, allowing collections of proprietary content to be made available only to users with adequate account credentials, as seen below.

In some examples, a node collection can store a type of educational resource. For example, all YouTube videos would be stored together in a collection with relevant identifier information needed to serve these resources to a client. Separate node collections can include Wikipedia articles, testing resources (quizzes, etc.), and so forth. Alternatively, the educational resources could be stored in more compact, category-specific or learning goal-specific node collections. For example, YouTube chemistry videos would be stored in a first node collection, whereas YouTube mathematics education videos would be stored in a second node collection.

In some examples, a node collection can store a concept, or a type of concept. As above, concept collection could require sharding by knowledge category or other categorical differentiators to reduce loading, processing and/or querying times. In some examples, node collections storing concepts can implement a tiered-moderator permission system, or restrict moderator access to concepts within specific knowledge domains (see, e.g., FIG. 21). In some examples, such a permission system can be implemented using the authentication and/or security features offered by ArangoDB. In some examples, separate resource node collections or concept node collections can be used to store proprietary content controlled by a business client. By separating business client-owned or controlled content, the system 100 enables access to this content to be restricted to users and moderators associated with the business client, or given access permissions by the business client.

In some examples, an edge collection can have one of at least three types: moderator-controlled, proprietary, or aggregate. System 100 can store and/or use multiple edge collections. Edge collections can be used to create educational experiences in the context of specific access modes, for example via the client application 102. Edge collections can be created, via the collection builder module 2104.

Moderator-Controlled Edge Collections Such collections are created and/or controlled by moderators, and/or contain varying degrees of relationship specificity. Moderators are prompted to create a map of relationships between concepts, relationships between concepts and educational resources, or relationships between educational resources. The concepts and/or educational resources can be part of aggregate node collections that are accessible to the moderator, or can be part of moderator-controlled node collections.

If a moderator-controlled edge collection includes relationships involving learning resources and/or testing resources, the system 100 will use such resources as preferred or primary recommendations to a user navigating the collection or working within the collection. For example, a user exploring a concept and interested in viewing a video related to the concept via an IS_INTEREST relationship can choose among a set of selected and/or ranked videos connected to the concept via an IS_INTEREST edge in the moderator-controlled edge collection. Similarly, a testing resource can be selected by the user among a selected and/or ranked set of testing resources connected to the concept via IS_TEST edges.

If a concept lacks an associated learning/testing resource, the system 100 will automatically recommend one or more associated learning/testing resource from an aggregate collection (e.g., a full collection or default knowledge graph). Similarly, if a concept lacks additional related concepts, the system 100 can recommend a related concept from an aggregate collection, or a related concept from another content collection linked to the initial concept via an edge in an aggregate edge collections. The collection builder module 2104 can prompt moderators controlling the collection to specify an alternative moderator-controlled collection as a preferred source of recommendation relationships involving educational resources and/or related concepts if such recommendation relationships are missing for specific concepts.

Proprietary Edge Collections Edge collections including proprietary content, or connecting node collections including proprietary content can be implemented as moderator-controlled collections affiliated with an organization. For example, the organization can provide a list of associated potential administrators, and the system 100 can elicit and receive a final choice of an administrator from the respective list.

Aggregate Edge Collections In some examples, an aggregate edge collection corresponds to an edge collection storing each unique concept-to-concept relationship that occurs in any non-proprietary edge collection (e.g., aggregated relationships 3110 in FIG. 31). Each relationship or edge in the aggregate edge collection stores a count parameter representing the number of edge collections which include the relationship. The aggregate edge collection corresponds to a concept map that allows users to explore related concepts outside the bounds of a specific active learning experience, such as a learning experience generated from a moderator-created collection. The aggregate edge collection can be used by the system 100 to automatically determine the strength of the relationship between any concepts based on the stored count parameter, on other count parameters associated with other relationships between the two concepts, and so forth. The determined relationship strength can be used by the system 100 to generate pathways between a user and specific concept goals. The aggregate edge collection can be used to avoid relationship loops or other graph-related undesired artifacts among concepts in generated navigational paths or choices.

In some examples, an aggregate edge collection stores relationships provided by a tier 1 moderator between concepts and content items (e.g., aggregated connections 3108 in FIG. 31). Such an aggregate edge collection can be used to serve resources in moderator-controlled collections that only specify concept-concept relationships. It further prevents duplicate storage of resources within the index, and/or provides a library of resources from which tier 2 moderators can select resources to include within their more specific collections.

In some examples, an aggregate collection stores subsets of concept-concept relationships or concept-resource relationships generated or validated by a tier 2 moderator. Such relationships can be automatically made available to moderators within the collection builder module 2104, as library of building blocks that can be selectively used by these moderators for inclusion into collections under their control.

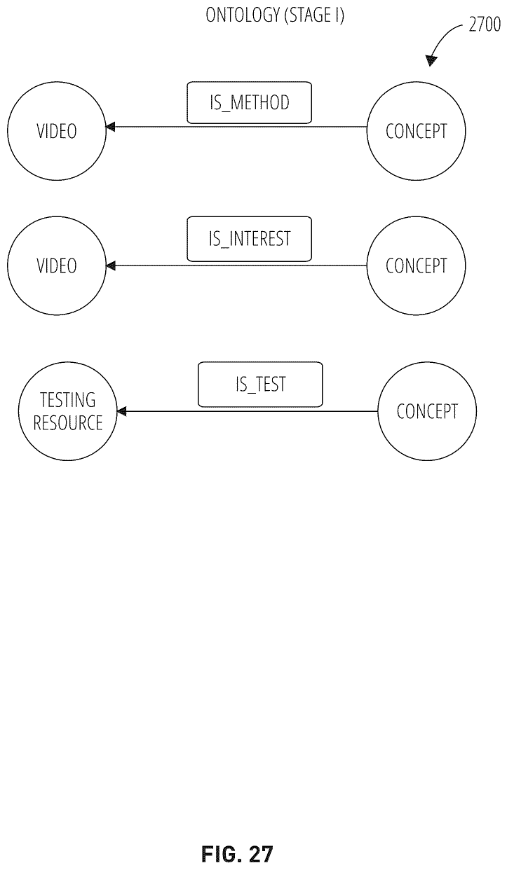

FIG. 27 is a block diagram illustrating a partial view 2700 of a relationship ontology, according to some examples. FIG. 27 illustrates example relationships between concepts and educational resources, such as IS_METHOD, IS_INTEREST, IS_TEST.

FIG. 28 is a block diagram illustrating a partial view 2800 of a relationship ontology, according to some examples. FIG. 28 illustrates relationships between concepts, such as, IS_NARROWER, PERSON_FOR, EVENT_FOR, SIMILAR, etc. Relationships can have different specificity levels. For example, the EVENT_FOR relationship is a type of RELATED_EVENT relationship, and so forth.

FIG. 29 is a block diagram illustrating two partial views of two collections (2916 and 2924) that can be aggregated to produce a combined collection 2926, according to some examples.

Example collections 2916 and 2924 can include the same concepts (e.g., concepts 2902, 2904, 2906, 2908, 2918), but different relationships (e.g., in collection 2916, concept 2902 is linked to concept 2906 by relationship 2910, while in collection 2924 the same concepts are linked by relationship 2920).

Collection 2926 includes, in some examples, a superset of concepts included in collections 2916 and 2924, and a set of relationships that may overlap with one or both of the relationship sets for collections 2916 and 2924. Collection 2926 can include the same concepts 2902 and 2906 as included in both collections 2916 and 2924. In some examples, concepts 2902 and 2906 are linked by relationship 2920 in the context of collection 2926 (e.g., given the different relationships linking the concept pair in collections 2916 and 2924, one of the relationships is chosen as the link for the aggregated collection 2926).

In some examples, two or more collections can be automatically combined to generate an aggregate collection. In some examples, the aggregate collection can include some or all of the available collections. An aggregate collection that is a union or superset of the available collections can correspond to a default content collection and/or a complete knowledge graph or knowledge map. Collection aggregation can be a multistep, iterative process. In some examples, collection aggregation can include automatically eliciting input from moderators or content creators interacting with an example moderator studio application 114 (see the detailed description of FIG. 21).

In some examples, tuples of concepts that appear in different collections as linked by different relationships can be included in the final combined collection, or omitted from the collection. A final relationship linking the respective concepts in a tuple can be automatically selected based at least in part on weights associated with relationship edges in the specific conflicting collections, the relative (or normalized) frequency of each relationship across a set of collections including the tuple of concepts, meta-dependencies among relationships (e.g., BROADER_THAN and NARROWER_THAN are inverse relationships in the context of a pair of concepts), and more. In some examples, a final relationship linking the tuple concepts in the combined collection may be a relationship different from those linking the concepts in the set of conflicting collections (or no relationship may be included). In some examples, the final relationship linking the tuple concepts in the combined collection may be selected based in part on automatically elicited input from a moderator or creator, via a UI element displaying the tuple concepts, a set of relationships, and user-selectable element(s) corresponding to selecting one of the set of relationships to link the tuple concepts in the combined collection.

In some examples, collection aggregation can include a loop removal operation. In some examples, collection aggregation may include one or more relationship (or edge) completion operations: given a concept in a final, combined collection that is not connected to any other concept in the final collection, a relationship completion operation may automatically generate a list of K ranked suggestions for relationships connecting the concept to one or more other concepts in the collection (where K>=1).

In some examples, in addition or instead of creating a unified or aggregated knowledge map, the system can allow users exploring a collection (e.g., in an active learning mode) to directly cross over to a related, separate collection. For example, a user exploring collection 2924 can be recommended relationship 2914 (involving concept 2918), as it is a potentially relevant relationship in the context of a user's learning goal, even though it is part of a separate collection. In this fashion, a user may traverse multiple collections in real time, even in the absence of a precomputed, default knowledge map. In some examples, a user may have the option of real-time cross-boundary collection exploration in addition to exploring a precomputed, default knowledge map.

FIG. 30 is a block diagram illustrating a partial view 3000 of a collection, according to some examples, as stored in a database 126. The collection 3020 includes a set of concepts (e.g., 3002, 3004, . . . 3010) together with a set of relationships (e.g., 3012 . . . 3018) from one or more ontologies. Relationships can link two or more concepts, and can include BROADER_THAN, NARROWER_THAN, SIMILAR, RELATED_PERSON, RELATED_EVENT, and so forth. In some examples, relationships have one or more associated weights, determined in ways similar to the description of FIG. 26.

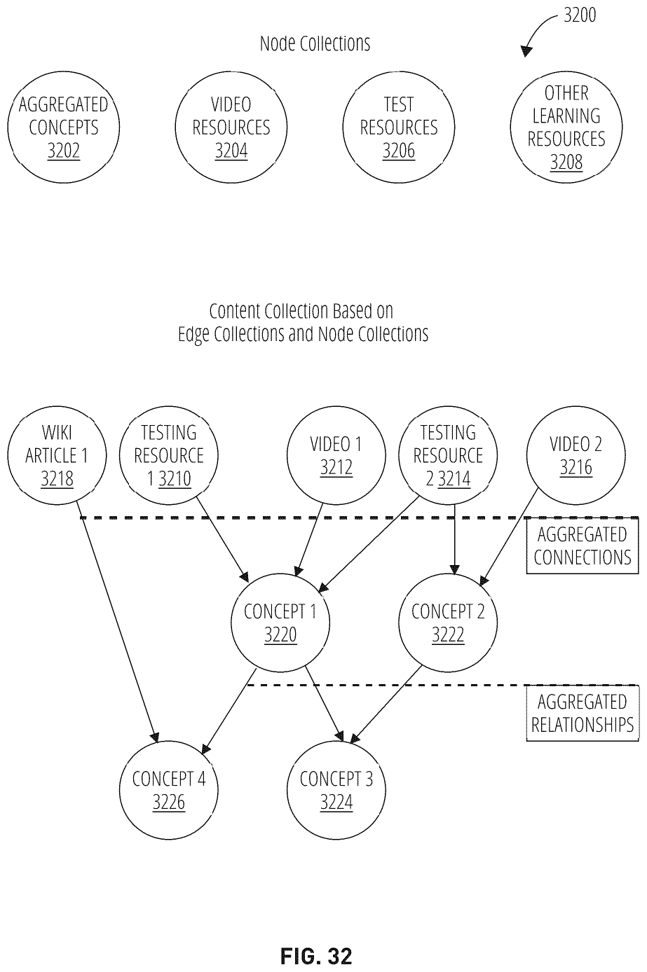

FIG. 31 is a diagrammatic illustration 3100 of node and edge collections, according to some examples. The aggregated concepts 3104 node collection is specified as a “FROM” node collection, and also as a “TO” node collection. The video resources 3118, test resources 3120, other learning resources 3122 are specified as “TO” node collections. Aggregated relationships 3110 corresponds to an edge collection where the edges connect concepts from the 3104 and 3116 node collections. Aggregated connections 3108 corresponds to an edge collection connecting concepts and educational resources (e.g., concepts from 3104 and resources from 3118, 3120 and 3122, etc.). The system 100 can use these nodes and edge collections to automatically generate a navigable graph that allows navigation among concepts and/or available resources for concepts (see, e.g. FIG. 32). Such a navigable graph corresponds to a possible implementation of a content collection.

FIG. 32 is a diagrammatic illustration of a navigable graph generated based on node and edge collections, according to some examples. Example node and edge collections are detailed in FIG. 31. The generated navigable graph corresponds to an example implementation of a content collection.

In some examples, the generated navigable graph corresponds to a free exploration experience. Such a navigation experience can support any user interaction or user access mode that lacks more restricted navigation options. For example, such a navigation experience can enable or support an explore mode, a search mode, a program mode, a review access mode including accessing a user progress page, a review model corresponding to reviewing a concept from a missed quiz questions, and/or a daily learning mode. The navigable graph can be created via an ArangoDB API, based on node collections and/or edge collections stored in an multi-model ArangoDB.

FIG. 33 is an illustration of a partial view 3300 of a content collection. The content collection can be represented as a navigable graph generated based on node collections and/or an edge collection (see, e.g., FIG. 31, FIG. 32). The collection in FIG. 33 includes mathematical concepts, together with educational resources. Mathematical concepts are connected via relationships such as IS_NARROWER (e.g., Counting_Numbers is narrower than Counting). Mathematical concepts and educational resources are connected via relationships such as IS_INTEREST, IS_METHOD, and so forth.

FIG. 34 is a flowchart corresponding to a method 3400 for accessing a content collection, according to some examples, as implemented by system 100. At operation 3402, method 3400 causes display (e.g., at a client device), of a UI that includes a user-selectable access mode interface element and a first view of a content collection (see operation 3404).

In some examples, the access mode is one of a number of modes used by a learner interacting with a collection, such as a search mode, an explore mode, a focus mode such as a program mode or a quiz mode, and so on. In some examples, the access mode is one of a number of modes used by a creator or moderator interacting with a collection, such as a content adding mode, a review mode, an edit mode, a suggestion mode, and so on.

In some examples, a first view of the content collection includes a concept, while the content collection includes concept pairs and associated relationship links.

At operation 3406, system 100 detects, at a client device, a user selection of the user-selectable access mode interface element. At operations 3408 and 3410, upon detecting the selection of the access mode interface element, system 100 generates and displays at the client device a second view of the content collection. The second view of the content collection is generated based on attributes of the access mode. For example, explore mode can allow exploration outside the boundary of the current collection, while a focus mode such as a program mode does not. In some examples, the second view is generated taking into account the profile of the user. For example, learner and moderators interact differently with the system. Furthermore, system 100 can take into account a user's background, preferences, learning or teaching goals, progress based on benchmarks to generate a second view of the content collection. In some examples, the second view includes a second concept.

FIG. 35 is a block diagram illustrating components of a machine 3500, according to some example embodiments, able to read instructions from a machine-readable medium (e.g., a machine-readable storage medium) and perform any one or more of the methodologies discussed herein. Specifically, FIG. 35 shows a diagrammatic representation of the machine 3500 in the example form of a computer system, within which instructions 3512 (e.g., software, a program, an application, an applet, an app, or other executable code) for causing the machine 3500 to perform any one or more of the methodologies discussed herein may be executed. As such, the instructions 3512 may be used to implement modules or components described herein. The instructions 3512 transform the general, non-programmed machine 3500 into a particular machine 3500 programmed to carry out the described and illustrated functions in the manner described. In alternative embodiments, the machine 3500 operates as a standalone device or may be coupled (e.g., networked) to other machines. In a networked deployment, the machine 3500 may operate in the capacity of a server machine or a client machine in a server-client network environment, or as a peer machine in a peer-to-peer (or distributed) network environment. The machine 3500 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 3512, sequentially or otherwise, that specify actions to be taken by machine 3500. Further, while only a single machine 3500 is illustrated, the term “machine” shall also be taken to include a collection of machines that individually or jointly execute the instructions 3510 to perform any one or more of the methodologies discussed herein.

The machine 3500 may include processors 3506, memory memory/storage 3508, and I/O components 3520, which may be configured to communicate with each other such as via a bus 3504. The memory/storage 3508 may include a memory 3516, such as a main memory, or other memory storage, and a storage unit 3518 both accessible to the processors 3506 such as via the bus 3504. The storage unit 3518 and memory 3516 store the instructions 3512 embodying any one or more of the methodologies or functions described herein. The instructions 3512 may also reside, completely or partially, within the memory 3516, within the storage unit 3518, within at least one of the processors 3506 (e.g., within the processor's cache memory), or any suitable combination thereof, during execution thereof by the machine 3500. Accordingly, the memory 3516, the storage unit 3518, memory 3516 and the memory of processors 3506 are examples of machine-readable media.

The I/O components 3520 may include a wide variety of components to receive input, provide output, produce output, transmit information, exchange information, capture measurements, and so on. The specific I/O components 3520 that are included in a particular machine 3500 will depend on the type of machine. For example, portable machines such as mobile phones will likely include a touch input device or other such input mechanisms, while a headless server machine will likely not include such a touch input device. It will be appreciated that the I/O components 3520 may include many other components that are not shown in FIG. 11. The I/O components 3520 are grouped according to functionality merely for simplifying the following discussion and the grouping is in no way limiting. In various example embodiments, the I/O components 3520 may include output components 3528 and input components 3530 The output components 3528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 3530 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 3520 may include biometric components 3532, motion components 3536, environmental environment components 3538, or position components 3540 among a wide array of other components. For example, the biometric components 3532 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 3536 may include acceleration sensor components (e.g., accelerometer), gravitation sensor components, rotation sensor components (e.g., gyroscope), and so forth. The environment components 3538 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 3538 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 3520 may include communication components 3542 operable to couple the machine 3500 to a network 3534 or devices 3522 via coupling 3526 and coupling 3524 respectively. For example, the communication components 3542 may include a network interface component or other suitable device to interface with the network 3532. In further examples, communication components 3542 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 3522 may be another machine or any of a wide variety of peripheral devices (e.g., a peripheral device coupled via a Universal Serial Bus (USB)).

Moreover, the communication components 3542 may detect identifiers or include components operable to detect identifiers. For example, the communication components 3542 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 3542, such as, location via Internet Protocol (IP) geo-location, location via Wi-Fi® signal triangulation, location via detecting a NFC beacon signal that may indicate a particular location, and so forth.

FIG. 36 is a block diagram showing a machine-learning program 3600 according to some examples. The machine-learning programs 3600, also referred to as machine-learning algorithms or tools, are used to train machine learning models, which can be used by the system 100.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 3610 in order to make data-driven predictions or decisions expressed as outputs or assessments (e.g., assessment 3618). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 3600 supports two types of phases, namely a training phase 3604 and prediction phase 3606. In a training phase 3604, supervised learning, unsupervised or reinforcement learning may be used. For example, the machine-learning program 3600 (1) receives features 3608 (e.g., as structured or labeled data in supervised learning) and/or (2) identifies features 3608 (e.g., unstructured or unlabeled data for unsupervised learning) in training data 3610. In a prediction phase 3606, the machine-learning program 3600 uses the features 3608 for analyzing query data 3614 to generate outcomes or predictions, as examples of an assessment 3618.

In the training phase 3604, feature engineering is used to identify features 3608 and may include identifying informative, discriminating, and independent features for the effective operation of the machine-learning program 3600 in pattern recognition, classification, and regression. In some examples, the training data 3610 includes labeled data, which is known data for pre-identified features 3608 and one or more outcomes. Each of the features 3608 may be a variable or attribute, such as individual measurable property of a process, article, system, or phenomenon represented by a data set (e.g., the training data 3610). Features 3608 may also be of different types, such as numeric features, strings, and graphs, and may include one or more of content 3620, concepts 3622, attributes 3624, historical data 3626 and/or user data 3628, merely for example.

In training phases 3604, the machine-learning program 3600 uses the training data 3610 to find correlations among the features 3608 that affect a predicted outcome or assessment 3618.

With the training data 3610 and the identified features 3608, the machine-learning program 3600 is trained during the training phase 3604 at machine-learning program training 3612. The machine-learning program 3600 appraises values of the features 3608 as they correlate to the training data 3610. The result of the training is the trained machine-learning program 3616 (e.g., a trained or learned model).

Further, the training phases 3604 may involve machine learning, in which the training data 3610 is structured (e.g., labeled during preprocessing operations), and the trained machine-learning program 3616 implements a relatively simple neural network 3630 (or one of other machine learning models, as described herein) capable of performing, for example, classification and clustering operations. In other examples, the training phase 3604 may involve deep learning, in which the training data 3610 is unstructured, and the trained machine-learning program 3616 implements a deep neural network 3630 that is able to perform both feature extraction and classification/clustering operations.

A neural network 3630 generated during the training phase 3604 and implemented within the trained machine-learning program 3616 may include a hierarchical (e.g., layered) organization of neurons. For example, neurons (or nodes) may be arranged hierarchically into a number of layers, including an input layer, an output layer, and multiple hidden layers. The layers within the neural network 3630 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 3630 may also be one of a number of different types of neural networks, including a single-layer feed-forward network, an Artificial Neural Network (ANN), a Recurrent Neural Network (RNN), a symmetrically connected neural network, and unsupervised pre-trained network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

During prediction phase 3606 the trained machine-learning program 3616 is used to perform an assessment, generate inferences, outcomes, or predictions. Query data 3614 is provided as an input to the trained machine-learning program 3616, and the trained machine-learning program 3616 generates the assessment 3618 as output, responsive to receipt of the query data 3614. The assessment 3618 can include prediction and/or inference data.

In some examples, the trained machine-learning program 3616 may be a generative AI model. Generative AI is a term that may refer to any type of artificial intelligence that can create new content from training data 3610. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code. In some examples, transformer models are pre-trained and/or can be fine-tuned and used for a variety of prediction, translation, summarization, generation, query answering tasks. Transformer models and/or architectures are examples of architectures that power large language models (LLMs). LLM examples include BERT, models in the CLAUDE LLM family (e.g, CLAUDE 3.0, etc.), ERNIE, FALCON-40B, Gemini, Gemma, GPT models (GPT-3.5, GPT-4, and follow-up models), Mistral, models in the Llama family (e.g, Llama 2, Llama 3, and/or follow-up models), and so forth. In some examples, LLMs can be powered by other architectures (e.g., Retentive Network, etc.) or by architectures that combine transformers with additional models.

In generative AI examples, the output or assessment 3618 include predictions, translations, summaries, media content, answers to queries or questions, and so forth.

### Example: Storing a Trained Model with ONNX File Format

A trained neural network model (e.g., a trained machine learning machine-learning program 3600 using a neural network 3630) may be stored in a computational graph format, according to some examples. An example computational graph format is the Open Neural Network Exchange (ONNX) file format, an open, flexible standard for storing models which allows reusing models across deep learning platforms/tools, and deploying models in the cloud (e.g., via ONNX runtime).

In some examples, the ONNX file format corresponds to a computational graph in the form of a directed graph whose nodes (or layers) correspond to operators and whose edges correspond to tensors. In some examples, the operators (or operations) take the incoming tensors as inputs, and output result tensors, which are in turn used as inputs by their children.

In some examples, trained neural network models (e.g., examples of trained machine learning machine-learning programs 3600) developed and trained using frameworks such as TensorFlow, Keras, PyTorch, and so on can be automatically exported to the ONNX format using framework-specific export functions. For instance, PyTorch allows the use of a torch.export(trainedModel, outputFile( . . . )) function to export a trained model ready to be run to a file using the ONNX file format. Similarly, TensorFlow and Keras allow the use of the tf2onnx library for converting trained models to the ONNX file format, while Keras also allows the use of keras2onnx for the same purpose.

In example embodiments, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

### Examples

Example 1 is a method comprising: causing display, at a client device, of a user interface (UI) that includes: a first view of a content collection that comprises concept pairs and associated relationship links, the first view including a first concept; and a user-selectable access mode interface element; detecting a first user selection, at the client device, of the user-selectable access mode interface element; upon detecting the first selection of the user-selectable access mode interface element, causing display, at the client device, of a second view of the content collection, the second view comprising a second concept, the second view being generated based on at least attributes of the access mode and a user profile associated with the user.

In Example 2, the subject matter of Example 1 includes, wherein: the user profile corresponds to a learner user profile; the access mode corresponds to an explore mode; and generating the second view of the content collection further comprises: detecting a second user selection, at the client device, of a user-selectable relationship interface element associated with a relationship link type of one or more of the relationship links of the content collection; upon detecting the second user selection of the user-selectable relationship interface element, displaying selectable concepts connected to the first concept based on respective relationship links of the relationship link type; upon detecting a third user selection of a concept of the selectable concepts, determining the second concept of the second view of the content collection to be the selected concept.

In Example 3, the subject matter of Examples 1-2 includes, wherein: the user profile corresponds to a learner user profile; the access mode corresponds to an explore mode; and the method further comprises: detecting a second user selection, at the client device, of a second user-selectable relationship interface element associated with a relationship link type of one or more of the relationship links of the content collection; upon detecting the second user selection of the second user-selectable relationship interface element, displaying a set of selectable content items connected to the first concept based on respective relationship links of the relationship link type; upon detecting a third user selection, at the client device, of a content item of the set of selectable content items, displaying the content item in the UI.

In Example 4, the subject matter of Example 3 includes, wherein the set of selectable content items is generated using a machine-learning (ML) model and one or more of at least the user profile, characteristics of the respective relationship links connecting the selectable content items to the first concept, characteristics of the content item, or characteristics of user interactions with content items in the content collection.

In Example 5, the subject matter of Examples 1-4 includes, causing display, at the client device, of a third view of an additional content collection, wherein: the user profile corresponds to a learner user profile; the access mode corresponds to an explore mode; the additional content collection is a default content collection; the first concept is included in the content collection and in the additional content collection; the third view comprises a third concept included in the additional content collection; the third view is generated based on the attributes of the access mode and the user profile associated with the user; and generating the third view further comprises detecting a third user selection, at the client device, of a user-selectable relationship interface element associated with a relationship link included in the additional content collection, the relationship link connecting the first concept and the third concept.

In Example 6, the subject matter of Examples 1-5 includes, wherein: the user profile corresponds to a learner user profile; the access mode corresponds to a program mode; the content collection corresponds to a program collection and generating the second view of the content collection further comprises determining that the second concept follows the first concept in a retrieved sequence of concepts associated with the program collection.

In Example 7, the subject matter of Example 6 includes, detecting a user selection of a user-selectable assessment interface element; upon detecting the user selection of a user-selectable assessment interface element, displaying a testing resource retrieved based on the first concept, the user profile of the user, and a priority pool of testing resources associated with the first concept.

In Example 8, the subject matter of Examples 1-7 includes, wherein; the user profile corresponds to a moderator user profile: the access mode corresponds to a content adding mode; the method further comprises: causing display, at the client device, of a concept submission UI associated with the content collection; detecting, at the client device, user input associated with a new concept, the user input being received in a text box of the concept submission UI or based on a user selection of an interactive menu element in the concept submission UI; detecting, at the client device, a user selection of a user-selectable relationship interface element associated with a relationship link type corresponding to one or more of the relationship links of the content collection; upon detecting the user selection of the user-selectable relationship interface element, displaying selectable concepts of the content collection; upon detecting a user selection of a concept of the selectable concepts, generating a new relationship link connecting the new concept and the selected concept.

In Example 9, the subject matter of Example 8 includes, wherein the content collection is enabled to be modified by the user based on a permission system, and wherein the method further comprises: adding the new concept to the content collection; and adding the new relationship link to the content collection.

In Example 10, the subject matter of Example 9 includes, wherein the content collection is not enabled to be modified by the user based on the permission system, and wherein the method further comprises storing the new concept and the new relationship link for review by an additional moderator, the content collection being enabled to be modified by the additional moderator based on the permission system.

In Example 11, the subject matter of Examples 1-10 includes, wherein: the user profile corresponds to a moderator user profile: the access mode corresponds to a content adding mode; and the method further comprises causing display, at the client device, of a program creation UI, the program creation UI comprising one or more of at least an interactive concept selection interface element, an interactive concept sequence building interface element, or an interactive resource selection interface element comprising an interactive difficulty level selection element.

In Example 12, the subject matter of Examples 1-11 includes, wherein: the user profile corresponds to a moderator user profile: the access mode corresponds to a content adding mode; the method further comprises causing display, at the client device, of a testing resource creation UI, the testing resource creation UI comprising one or more of at least testing resource type selection element, an interactive concept selection interface element, and an interactive answer choice selection element.

Example 13 is at least one non-transitory machine-readable medium (or computer-readable medium) including instructions that, when executed by processing circuitry, cause the processing circuitry to perform operations to implement of any of Examples 1-12.

Example 14 is an apparatus comprising means to implement any of Examples 1-12.

Example 15 is a system to implement any of Examples 1-12.

Example 16 is a method to implement any of Examples 1-12.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per sc.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

What is claimed is:

1. A method comprising:
causing display, at a client device, of a user interface (UI) that includes:
a first view of a content collection that comprises concept pairs and associated relationship links, the first view including a first concept; and
a user-selectable access mode interface element;
detecting a first user selection, at the client device, of the user-selectable access mode interface element; and
upon detecting the first selection of the user-selectable access mode interface element, causing display, at the client device, of a second view of the content collection, the second view comprising a second concept, the second view being generated based on at least attributes of the access mode and a user profile associated with the user.

2. The method of claim 1, wherein:
the user profile corresponds to a learner user profile;
the access mode corresponds to an explore mode; and
generating the second view of the content collection further comprises:
detecting a second user selection, at the client device, of a user-selectable relationship interface element associated with a relationship link type of one or more of the relationship links of the content collection;
upon detecting the second user selection of the user-selectable relationship interface element, displaying selectable concepts connected to the first concept based on respective relationship links of the relationship link type;
upon detecting a third user selection of a concept of the selectable concepts, determining the second concept of the second view of the content collection to be the selected concept.

3. The method of claim 1, wherein:
the user profile corresponds to a learner user profile;
the access mode corresponds to an explore mode; and
the method further comprises:
detecting a second user selection, at the client device, of a second user-selectable relationship interface element associated with a relationship link type of one or more of the relationship links of the content collection;
upon detecting the second user selection of the second user-selectable relationship interface element, displaying a set of selectable content items connected to the first concept based on respective relationship links of the relationship link type;
upon detecting a third user selection, at the client device, of a content item of the set of selectable content items, displaying the content item in the UI.

4. The method of claim 3, wherein the set of selectable content items is generated using a machine-learning (ML) model and one or more of at least the user profile, characteristics of the respective relationship links connecting the selectable content items to the first concept, characteristics of the content item, or characteristics of user interactions with content items in the content collection.

5. The method of claim 1, further comprising causing display, at the client device, of a third view of an additional content collection, wherein:
the user profile corresponds to a learner user profile;
the access mode corresponds to an explore mode;
the additional content collection is a default content collection;
the first concept is included in the content collection and in the additional content collection;
the third view comprises a third concept included in the additional content collection;
the third view is generated based on the attributes of the access mode and the user profile associated with the user; and
generating the third view further comprises detecting a third user selection, at the client device, of a user-selectable relationship interface element associated with a relationship link included in the additional content collection, the relationship link connecting the first concept and the third concept.

6. The method of claim 1, wherein:
the user profile corresponds to a learner user profile;
the access mode corresponds to a program mode;
the content collection corresponds to a program collection and
generating the second view of the content collection further comprises determining that the second concept follows the first concept in a retrieved sequence of concepts associated with the program collection.

7. The method of claim 6, further comprising:
detecting a user selection of a user-selectable assessment interface element;
upon detecting the user selection of a user-selectable assessment interface element, displaying a testing resource retrieved based on the first concept, the user profile of the user, and a priority pool of testing resources associated with the first concept.

8. The method of claim 1, wherein;
the user profile corresponds to a moderator user profile:
the access mode corresponds to a content adding mode;
the method further comprises:
causing display, at the client device, of a concept submission UI associated with the content collection;
detecting, at the client device, user input associated with a new concept, the user input being received in a text box of the concept submission UI or based on a user selection of an interactive menu element in the concept submission UI;
detecting, at the client device, a user selection of a user-selectable relationship interface element associated with a relationship link type corresponding to one or more of the relationship links of the content collection;
upon detecting the user selection of the user-selectable relationship interface element, displaying selectable concepts of the content collection;
upon detecting a user selection of a concept of the selectable concepts, generating a new relationship link connecting the new concept and the selected concept.

9. The method of claim 8, wherein the content collection is enabled to be modified by the user based on a permission system, and wherein the method further comprises:
adding the new concept to the content collection; and
adding the new relationship link to the content collection.

10. The method of claim 9, wherein the content collection is not enabled to be modified by the user based on the permission system, and wherein the method further comprises storing the new concept and the new relationship link for review by an additional moderator, the content collection being enabled to be modified by the additional moderator based on the permission system.

11. The method of claim 1, wherein:
the user profile corresponds to a moderator user profile:
the access mode corresponds to a content adding mode; and
the method further comprises causing display, at the client device, of a program creation UI, the program creation UI comprising one or more of at least an interactive concept selection interface element, an interactive concept sequence building interface element, or an interactive resource selection interface element comprising an interactive difficulty level selection element.

12. The method of claim 1, wherein:
the user profile corresponds to a moderator user profile:
the access mode corresponds to a content adding mode;
the method further comprises causing display, at the client device, of a testing resource creation UI, the testing resource creation UI comprising one or more of at least testing resource type selection element, an interactive concept selection interface element, and an interactive answer choice selection element.

13. A system comprising:
one or more computer processors;
one or more computer memories; and
a set of instructions stored in the one or more computer memories, the set of instructions configuring the one or more computer processors to perform operations, the operations comprising:
cause display, at a client device, of a user interface (UI) that includes:
a first view of a content collection that comprises concept pairs and associated relationship links, the first view include a first concept; and
a user-selectable access mode interface element;
detect a first user selection, at the client device, of the user-selectable access mode interface element; and
upon detecting the first selection of the user-selectable access mode interface element, cause display, at the client device, of a second view of the content collection, the second view comprising a second concept, the second view being generated based on at least attributes of the access mode and a user profile associated with the user.

14. The system of claim 13, wherein:
the user profile corresponds to a learner user profile;
the access mode corresponds to an explore mode; and
generating the second view of the content collection further comprises:
detecting a second user selection, at the client device, of a user-selectable relationship interface element associated with a relationship link type of one or more of the relationship links of the content collection;
upon detecting the second user selection of the user-selectable relationship interface element, displaying selectable concepts connected to the first concept based on respective relationship links of the relationship link type;
upon detecting a third user selection of a concept of the selectable concepts, determining the second concept of the second view of the content collection to be the selected concept.

15. The system of claim 13, wherein:
the user profile corresponds to a learner user profile;
the access mode corresponds to an explore mode; and
the operations further comprise:
detecting a second user selection, at the client device, of a second user-selectable relationship interface element associated with a relationship link type of one or more of the relationship links of the content collection;
upon detecting the second user selection of the second user-selectable relationship interface element, displaying a set of selectable content items connected to the first concept based on respective relationship links of the relationship link type;
upon detecting a third user selection, at the client device, of a content item of the set of selectable content items, displaying the content item in the UI.

16. The system of claim 15, wherein the set of selectable content items is generated using a machine-learning (ML) model and one or more of at least the user profile, characteristics of the respective relationship links connecting the selectable content items to the first concept, characteristics of the content items, or characteristics of user interactions with content items in the content collection.

17. The system of claim 13, the operations further comprising causing display, at the client device, of a third view of an additional content collection, wherein:
the user profile corresponds to a learner user profile;
the access mode corresponds to an explore mode;
the additional content collection is a default content collection;
the first concept is included in the content collection and in the additional content collection;
the third view comprises a third concept included in the additional content collection;
the third view is generated based on the attributes of the access mode and the user profile associated with the user; and
generating the third view further comprises detecting a third user selection, at the client device, of a user-selectable relationship interface element associated with a relationship link included in the additional content collection, the relationship link connecting the first concept and the third concept.

18. The system of claim 13, wherein:
the user profile corresponds to a learner user profile;
the access mode corresponds to a program mode;
the content collection corresponds to a program collection and
generating the second view of the content collection further comprises determining that the second concept follows the first concept in a retrieved sequence of concepts associated with the program collection.

19. The system of claim 18, the operations further comprising:
detecting a user selection of a user-selectable assessment interface element;
upon detecting the user selection of a user-selectable assessment interface element, displaying a testing resource retrieved based on the first concept, the user profile of the user, and a priority pool of testing resources associated with the first concept.

20. A non-transitory computer-readable storage medium, the computer-readable storage medium including instructions that when executed by a computer, cause the computer to:
cause display, at a client device, of a user interface (UI) that includes:
a first view of a content collection that comprises concept pairs and associated relationship links, the first view include a first concept; and
a user-selectable access mode interface element;
detect a first user selection, at the client device, of the user-selectable access mode interface element; and
upon detecting the first selection of the user-selectable access mode interface element, cause display, at the client device, of a second view of the content collection, the second view comprising a second concept, the second view being generated based on at least attributes of the access mode and a user profile associated with the user.
